(19) United States
(12) Patent Application Publication
(10) Pub. No.: US 2015/0309672 A1
(43) Pub. Date: Oct. 29, 2015

(54) MANAGEMENT APPARATUS METHOD FOR CONTROLLING MANAGEMENT APPARATUS, TERMINAL DEVICE, AND STORAGE MEDIUM

(71) Applicant: FURYU CORPORATION, Tokyo (JP)

(72) Inventors: Tetsuya MIWA, Tokyo (JP); Akiko TSUJI, Tokyo (JP); Juri KOMIYAMA, Tokyo (JP); Yoshiko TAKEMURA, Tokyo (JP); Koki IMAI, Tokyo (JP); Katsuya MOCHIZUKI, Tokyo (JP)

(21) Appl. No.: 14/641,260

(22) Filed: Mar. 6, 2015

(30) Foreign Application Priority Data
Mar. 20, 2014 (JP) 2014-058009

(51) Int. Cl. G06F 3/0482; G06F 3/0481; G06F 17/30

(52) U.S. Cl. CPC G06F 3/0482; G06F 17/30047; G06F 3/04817

(57) ABSTRACT

To allow a user to access a desired image rapidly, the present invention includes a web page creating section (413) for creating an image-list page (1041) including a plurality of album pages (1049) that are selectable for display and that serve to display on a portable terminal (6) a plurality of images which have been captured at a photograph sticker creating apparatus (1) and which are associated with the user, the web page creating section (413) being configured to sort the plurality of images into types on the basis of at least one of image processing information, object information, and operation information and to show the plurality of images on the plurality of album pages for the respective types.

This Nonprovisional application claims priority under 35 U.S.C. §119 on Patent Application No. 2014-058009 filed in Japan on Mar. 20, 2014, the entire contents of which are hereby incorporated by reference.

### TECHNICAL FIELD

The present invention relates to (i) a management apparatus for managing images captured at a photograph sticker creating apparatus, (ii) a method for controlling a management apparatus to manage such images, (iii) a terminal device for displaying an image captured at a photograph sticker creating apparatus, (iv) a program for controlling the terminal device, and (v) a computer-readable storage medium storing the control program.

### BACKGROUND ART

Many photograph sticker creating apparatuses in recent years have a function of transmitting a captured image to a management server. Users can use this function in various manners. For instance, the user can, as disclosed in Patent Literature 1, operate a portable terminal of his or her own to (i) download an image stored in a management server and (ii) display the image on the screen of the portable terminal for pleasure.

Further, to improve the user's convenience, the management server (i) creates an image-list page including a plurality of tab-selectable album pages for allowing images to be displayed on a portable terminal and (ii) allows the images to be displayed as sorted on the basis of tags, for example, by the apparatus model, in order of the save date and time, or in order of creation.

### CITATION LIST

Patent Literature 1

Japanese Patent Application Publication, Tokukai, No. 2010-009250 A (Publication Date: Jan. 14, 2010)

### SUMMARY OF INVENTION

### Technical Problem

The user may have several hundreds or more images stored in an album registration area of an image providing website. Conventional techniques such as the above problematically (i) fail to sort images sufficiently and (ii) impose a difficulty on the user in finding a desired image.

The present invention has been accomplished in view of the above problem. It is an object of the present invention to provide (i) a management apparatus capable of creating an image-list page allowing the user to access a desired image rapidly, (ii) a method for controlling such a management apparatus, (iii) a terminal device capable of displaying an image-list page, and (iv) a storage medium.

### Solution to Problem

In order to solve the above problem, a management apparatus of the present invention is a management apparatus for connecting to a terminal device of a user's and to a photograph sticker creating apparatus over a communication network and providing data displayable by the terminal device, the management apparatus including: a page creating section for creating an image-list page including a plurality of album pages that are selectable for display and that serve to display on the terminal device a plurality of images which have been captured at the photograph sticker creating apparatus and which are associated with the user, the page creating section being configured to sort the plurality of images into types on a basis of at least one of (i) image processing information indicative of a process having been performed on at least one of the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

In order to solve the above problem, a method of the present invention for controlling a management apparatus is a method for controlling a management apparatus for connecting to a terminal device of a user's and to a photograph sticker creating apparatus over a communication network and providing data displayable by the terminal device, the method including the step of: (a) creating an image-list page including a plurality of album pages that are selectable for display and that serve to display on the terminal device a plurality of images which have been captured at the photograph sticker creating apparatus and which are associated with the user, the step (a) being configured to sort the plurality of images into types on a basis of at least one of (i) image processing information indicative of a process having been performed on the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

With either of the above arrangements, the management apparatus is capable of causing a terminal device of the user's to display images, sorted into types on the basis of at least one of the image processing information, the object information, and the operation information, on a plurality of album pages for the respective types. The management apparatus sorts images different purposes as desired by the user and creates album pages for such purposes, which advantageously allows the user to access a desired image rapidly.

In order to solve the above problem, a terminal device of the present invention is a terminal device for (i) connecting over a communication network to a management apparatus for managing an image captured at a photograph sticker creating apparatus and (ii) receiving data from the management apparatus, the terminal device including: a page creating section for creating an image-list page including a plurality of album pages that are selectable for display and that show a plurality of images which have been captured at the photograph sticker creating apparatus and which are associated with a user, the page creating section being configured to sort the plurality of images into types on a basis of at least one of (i) image processing information indicative of a process having been performed on at least one of the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

With the above arrangement, the terminal device is capable of displaying images, sorted into types on the basis of at least one of the image processing information, the object information, and the operation information, on a plurality of album pages for the respective types. The terminal device sorts images different purposes as desired by the user and creates album pages for such purposes, which advantageously allows the user to access a desired image rapidly.

### Advantageous Effects of Invention

The present invention advantageously allows the user to access a desired image rapidly.

### BRIEF DESCRIPTION OF DRAWINGS

FIG. 1 is a block diagram illustrating a main part of a management server of a first embodiment of the present invention.

FIG. 2 is a diagram illustrating a captured-image management system of the first embodiment of the present invention.

FIG. 3 is a perspective view of a photograph sticker creating apparatus of the first embodiment of the present invention, the view illustrating an example appearance arrangement.

FIG. 4 is a perspective view of the photograph sticker creating apparatus of the first embodiment of the present invention, the view being taken at an angle different from that for FIG. 3.

FIG. 5 is a diagram illustrating a user's move in accordance with the first embodiment of the present invention.

FIG. 6 is a diagram illustrating example configuration of a photographing section included in the photograph sticker creating apparatus of the first embodiment of the present invention.

FIG. 7 is a diagram illustrating example configuration of a background section included in the photograph sticker creating apparatus of the first embodiment of the present invention.

FIG. 8 is a diagram illustrating example configuration of an editing section included in the photograph sticker creating apparatus of the first embodiment of the present invention.

FIG. 9 is a diagram illustrating example configuration of a post-service section included in the photograph sticker creating apparatus of the first embodiment of the present invention.

FIG. 10 is a block diagram illustrating an example internal configuration of the photograph sticker creating apparatus of the first embodiment of the present invention.

FIG. 11 is a functional block diagram illustrating detailed example configuration of a control section included in the photograph sticker creating apparatus of the first embodiment of the present invention.

FIG. 12 is a block diagram illustrating a main part of a portable terminal of the first embodiment of the present invention.

FIG. 13 is a screen flow diagram illustrating an example web page displayed on the display section of the portable terminal during a member registration process of the first embodiment of the present invention.

FIG. 14 is a sequence diagram illustrating an example flow of a series of steps, covering from photographing to image saving, in accordance with the first embodiment of the present invention.

FIG. 15 is a screen flow diagram illustrating an example web page displayed on the display section of the portable terminal during a process for saving an image onto the management server of the first embodiment of the present invention.

FIG. 16 is a sequence diagram illustrating an example flow of a series of steps involved in the saving of an image onto the portable terminal in the captured-image management system of the first embodiment of the present invention.

FIG. 17 is a screen flow diagram illustrating an example web page displayed on the display section of the portable terminal during a process for saving an image onto the portable terminal of the first embodiment of the present invention.

FIG. 18 is a diagram illustrating an example of image management information associated with images stored in an image database of a management apparatus.

FIG. 19 is a diagram illustrating an example of an event information correspondence table in which event information is associated with date-and-time information and edit information.

FIG. 20 is a diagram illustrating an example of manipulator information.

FIG. 21 is a diagram illustrating an example of collage information.

### DESCRIPTION OF EMBODIMENTS

### Embodiment 1

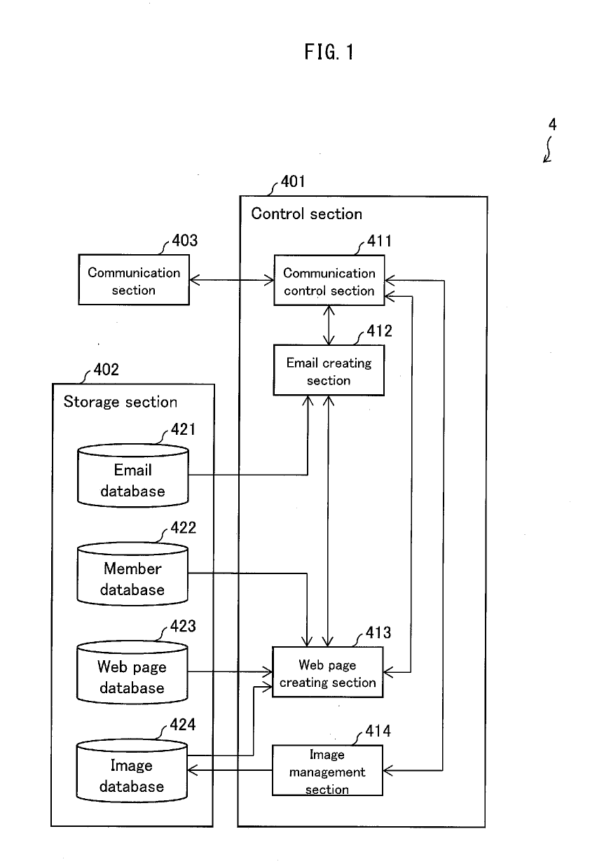

A first embodiment of the present invention is described below with reference to FIGS. 1 through 17. The description below deals with a main part of the arrangement of the specific embodiment, so the other part is not described. In the case where such other part of the arrangement is described for any other embodiment, it is as so described. Further, for convenience of description, any member having a function identical among different embodiments is assigned a common reference sign, and a description of such a member is omitted as appropriate. The shapes and dimensions (length, width, and depth) of the individual members illustrated in the drawings do not reflect the actual shapes and dimensions, and have been changed as appropriate for clear and simple illustrations.

(Captured-Image Management System 10)

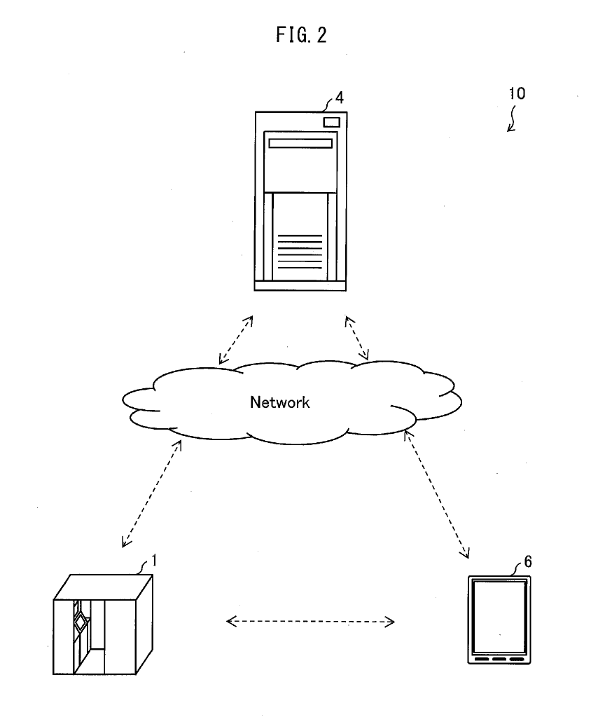

FIG. 2 is a diagram illustrating a configuration of a captured-image management system 10 of the first embodiment of the present invention. The captured-image management system 10 includes, as illustrated in FIG. 2, a photograph sticker creating apparatus 1, a portable terminal (terminal device) 6, and a management server (management apparatus) 4.

The captured-image management system 10 is outlined below. The captured-image management system 10 provides the user (or users; the same applies herein) with services of allowing the user to take a photograph, edit an image, print an image in the form of a photograph sticker, save an image onto an image providing website, and view an image stored. The services of taking a photograph, editing an image, and printing a photograph sticker are provided by the photograph sticker creating apparatus 1, which is installed at a store of a game arcade. The service of saving an image is provided by the management server 4, which manages an image providing website. The user can operate a portable terminal 6 of his or her own to save, onto the image providing website, an image that the user has captured. An image providing website is a website that allows the user to view (i) images that the user has captured and (ii) images that other users have captured. An image providing website further has an SNS (social networking service) function to allow communication between users on the website.

To save an image onto an image providing website, the user needs to register himself or herself as a member of the website in advance. The user can register himself or herself as a free member on the image providing website. A free member is not required to pay a membership fee, but is allowed to save only a limited number of images onto the image providing website. In the present embodiment, a free member is allowed to save only one image onto the image providing website per game (play).

The user can change his or her member status from a free member to a paid member. A paid member is required to pay a membership fee continuously, but is instead allowed to save an unlimited number of images onto the image providing website. In the present embodiment, a paid member is allowed to save, onto the image providing website, all images captured in each play.

The portable terminal 6 is a terminal device (communication terminal) carried by the user, and is, for example, a mobile telephone, a smart phone, or a tablet terminal. The portable terminal 6 is capable of communicating with the photograph sticker creating apparatus 1 with use of a wireless telecommunications means or a cable communications means. The portable terminal 6 is further capable of communicating with the management server 4 over a network to access an image providing website. The user can thus, by operating a portable terminal 6 that the user carries, (i) save onto an image providing website an image of the user's which image has been generated by the photograph sticker creating apparatus 1 or (ii) view such an image stored on the image providing website.

The user can access the image providing website also from a terminal device other than the portable terminal 6 (for example, a desktop or notebook PC).

The description below briefly deals with a flow of a process performed by the captured-image management system 10 which process starts with taking a photograph and ends with saving an image. One or more users (in this brief description, referred to as “the user”) put money into the photograph sticker creating apparatus 1 to play a game involving photograph taking and image editing. The user photographs himself or herself as a subject during the game. The user then (i) selects, from among images generated through the photography, one or more images to be edited and (ii) edits those selected images at will. Further, the user enters an email address of his or her own into the photograph sticker creating apparatus 1 to later save an image(s) onto an image providing website.

The user receives a photograph sticker after the end of the game. The photograph sticker creating apparatus 1 (i) associates the generated images with the user's email address entered, and (ii) transmits the images and email address to the management server 4. The management server 4 then transmits, to the email address received, an email that prompts the user to save, onto the image providing website, the images received. The user receives this email at a portable terminal 6 of his or her own. The email shows a procedure for saving images onto the image providing website. The user can follow that procedure on the portable terminal 6 to save images. This operation saves images in an image storage area of the image providing website which image storage area is dedicated to the user.

After saving an image onto the image providing website, the user can log in to the image providing website from the portable terminal 6 or another desired device and download the image onto a local storage.

(Arrangement of Photograph Sticker Creating Apparatus 1)

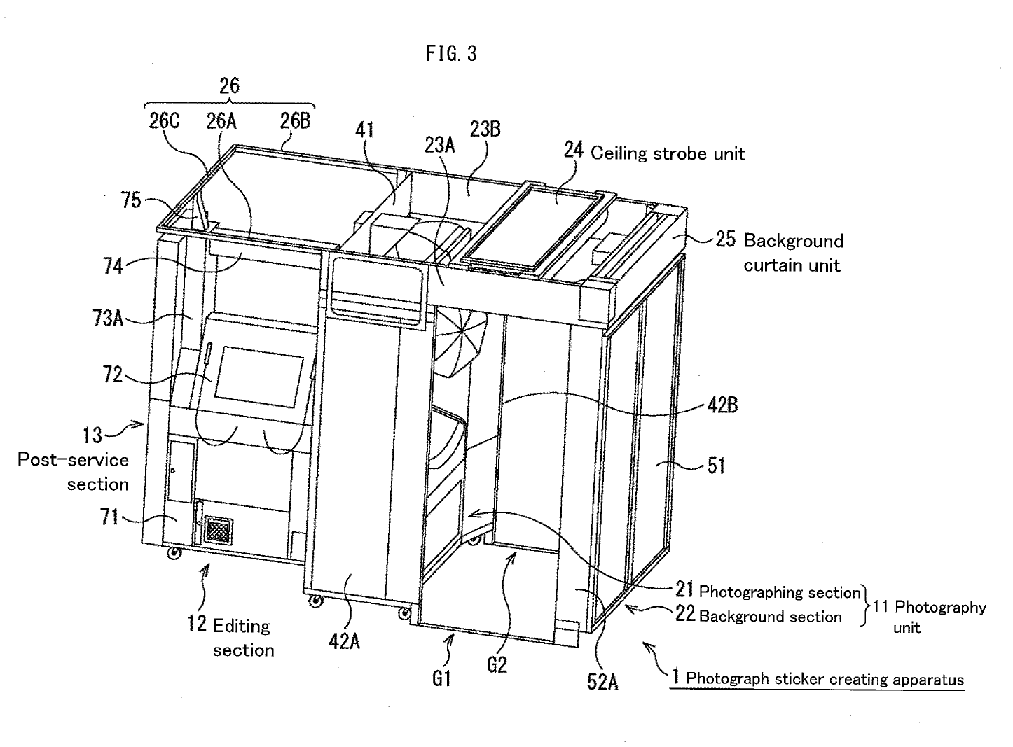

The description below deals in detail with arrangements and functions of the individual apparatuses (devices) constituting the captured-image management system 10. The description below first deals in detail with the photograph sticker creating apparatus 1 with reference to FIGS. 3 through 11. FIG. 3 is a perspective view of the photograph sticker creating apparatus 1 of the first embodiment of the present invention, the view illustrating an example appearance arrangement. The photograph sticker creating apparatus 1 includes, as illustrated in FIG. 3, a photography unit 11, an editing section 12, and a post-service section 13 as main components. The photograph sticker creating apparatus 1 is installed in such a manner that the photography unit 11 and the editing section 12 adjoin each other and that the editing section 12 and the post-service section 13 adjoin each other.

(Photography Unit 11)

The photography unit 11 includes a photographing section 21 and a background section 22 that are so installed as to be separated from each other by a predetermined distance. The photographing section 21 and the background section 22 define therebetween a photography space, in which the user performs a photography control.

The photographing section 21 is a device that allows the user to perform a photography control. The photographing section 21 is so positioned as to face the user who is in the photography space and who is performing a photography control. The photographing section 21 includes a front panel 41 that provides a surface facing the photography space. The front panel 41 is equipped with, for example, a touch panel monitor that the user uses during a photography control. The photographing section 21 includes a side panel 42A as a left-side surface (which is a surface located to the left as viewed from the user in the photography space) and a side panel 42B as a right-side surface (which is a surface located to the right as viewed from the user in the photography space).

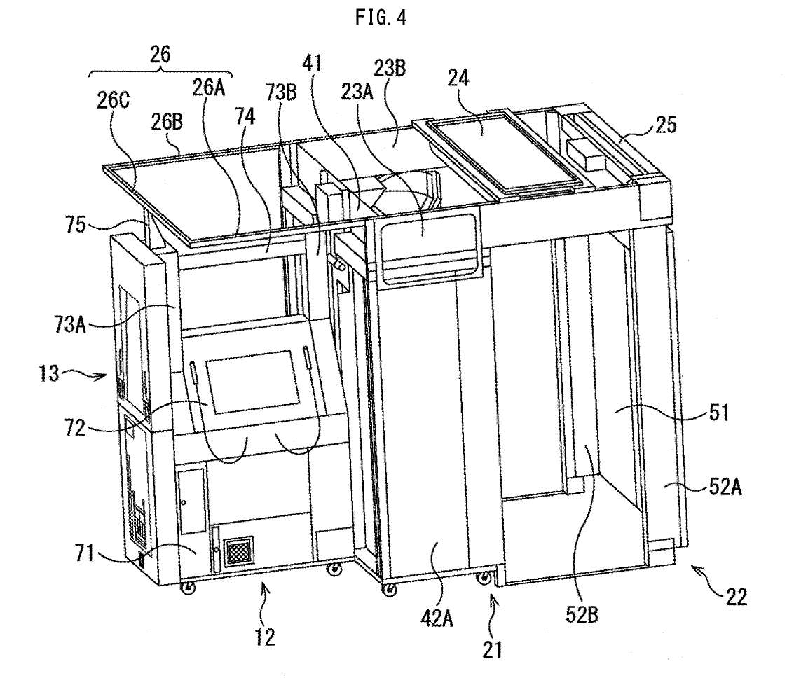

The background section 22 includes a back panel 51, a side panel 52A, and a side panel 52B. The back panel 51 is a plate-shaped member positioned behind the user facing the front panel 41 and performing a photography control. The side panel 52A is a plate-shaped member having a width smaller than that of the side panel 42A and attached to a left end of the back panel 51. The side panel 52B is a plate-shaped member having a width smaller than that of the side panel 42B and attached to a right end of the back panel 51 (see FIG. 4).

The side panel 42A (left-side surface) of the photographing section 21 and the side panel 52A of the background section 22 are substantially flush with each other, and are connected to each other at respective upper portions by means of a plate-shaped connecting section 23A. The side panel 42B (right-side surface) of the photographing section 21 and the side panel 52B of the background section 22 are substantially flush with each other, and are connected to each other at respective upper portions by means of a plate-shaped connecting section 23B.

The side panel 42A of the photographing section 21, the connecting section 23A, and the side panel 52A of the background section 22 define an opening to serve as an entrance G1 to the photography space. The side panel 42B of the photographing section 21, the connecting section 23B, and the side panel 52B of the background section 22 define an opening to serve as an entrance G2 to the photography space.

The background section 22 is provided with, at an upper portion thereof, a background curtain unit 25 supported by the back panel 51, the side panel 52A, and the side panel 52B. The background curtain unit 25 encases a plurality of wind-up background curtains each for use as a background and different from each other in color or design. The background curtain unit 25 operates in conjunction with photograph taking with the use of, for example, a camera included in the photographing section 21. For instance, when the user takes a photograph, the background curtain unit 25 draws down a curtain of the user's selected color and keeps the other curtains wound up.

The background curtain unit 25 may alternatively encase, as the background curtains, a liftable curtain, which includes a plurality of curtains to serve as a single chroma key curtain. Further alternatively, the photograph sticker creating apparatus 1 may be arranged to include (i) a chroma key curtain attached in advance to the back panel 51, which serves as a back surface for the photography space, and (ii) a plurality of background images for composition so that the user can superimpose a desire background image on the curtain for a composite image in performing an edit control described below.

The front panel 41 of the photographing section 21, the connecting section 23A, the connecting section 23B, and the background curtain unit 25 define an opening above the photography space, the opening being partially covered by a ceiling strobe unit 24. The ceiling strobe unit 24 has an end fixed to the connecting section 23A and another end fixed to the connecting section 23B. The ceiling strobe unit 24 contains a strobe for flashing light toward the photography space in synchronization with photograph taking. The strobe included in the ceiling strobe unit 24 contains a fluorescent lamp to function also as a lighting device for the photography space.

(Editing Section 12)

The editing section 12 is a device that allows the user to perform an edit control, which refers to a process of editing an image created through a photography control. The editing section 12 is connected to the photography unit 11 in such a manner as to have a side surface adjoining a back surface of the front panel 41 of the photographing section 21. The editing section 12 includes members such as a tablet-containing monitor that the user uses during an edit control.

Assuming that the members of the editing section 12 illustrated in FIG. 3 are those on the front-surface side, the editing section 12 includes members for use in an edit control on each of the front-surface side and the back-surface side to allow two groups of users to edit an image simultaneously.

The editing section 12 has, on the front-surface side, (i) a surface 71 perpendicular to the floor surface and substantially parallel to the side panel 42A and (ii) an inclined surface 72 located above the surface 71. The members for use in an edit control are disposed on the inclined surface 72. The editing section 12 includes, to the left of the inclined surface 72, a support section 73A having a pillar shape and supporting an illumination device 74 at an end thereof. The editing section 12 includes, on an upper surface of the support section 73A, a support section 75 supporting a curtain rail 26. The editing section 12 further includes, to the right of the inclined surface 72, a support section 73B supporting the illumination device 74 at another end thereof (see FIG. 4).

The editing section 12 is provided with a curtain rail 26 attached to an upper portion thereof. The curtain rail 26 includes three rails 26A to 26C combined in the shape of an angular U as viewed from above. The rail 26A has an end fixed to the connecting section 23A, whereas the rail 26B, which extends parallel to the rail 26A, has an end fixed to the connecting section 23B. The other end of the rail 26A is joined with an end of the remaining rail 26C, whereas the other end of the rail 26B is joined with the other end of the rail 26C.

The curtain rail 26 hangs a curtain so attached thereto as to (i) define a space on the front-surface side of the editing section 12 and hide the space from the outside and to (ii) define a space on the back-surface side of the editing section 12 and hide the space from the outside. The space on the front-surface side of the editing section 12 and the space on the back-surface side of the editing section 12, which spaces are defined by the curtain attached to the curtain rail 26, combine to form an edit space, in which the user performs an edit control.

(Post-Service Section 13)

FIG. 4 is a perspective view of the photograph sticker creating apparatus 1, the view being taken at an angle different from that for FIG. 3 to illustrate the appearance of the photograph sticker creating apparatus 1. The post-service section 13 is a device that provides a post-service and that allows the user to perform an operation for a post-service. Examples of the post-service include (i) a process of transmitting an image (which may have been edited) to the management server 4, (ii) a process of allowing the user to play a simple game, and (iii) a process of asking the user to answer a questionnaire.

The post-service section 13 includes, as illustrated in FIG. 4, a plate-shaped housing having a predetermined thickness. The post-service section 13 is connected to the editing section 12 in such a manner as to have a back surface adjoining a left-side surface of the editing section 12. The post-service section 13 includes, on a front surface thereof, such members as (i) a tablet-containing monitor that the user uses to perform an operation for a post-service and (ii) a discharge opening for discharging a sticker sheet on which images (which may have been edited) are printed. The post-service section 13 has, on its front-surface side, a post-service space, in which the user performs an operation for a post-service while waiting for images to be printed on a sticker sheet.

(User's Move)

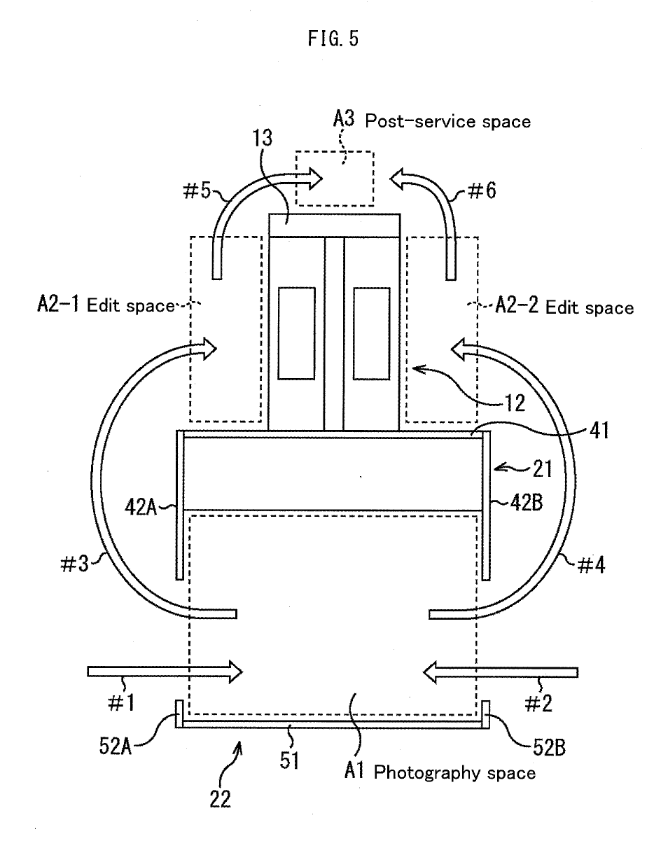

With reference to FIG. 5, the description below deals with a flow of a photograph sticker creating game and a user's move through the flow. FIG. 5 is a diagram illustrating a user's move.

A user of the photograph sticker creating apparatus 1 enters a photography space A1, defined between the photographing section 21 and the background section 22, through the entrance G1 as indicated by the hollow arrow #1 or through the entrance G2 as indicated by the hollow arrow #2. The user then performs a photography control with use of a camera and touch panel monitor, for example, included in the photographing section 21.

The user, when capturing an image, does not necessarily capture an image to be printed on a sticker sheet. The user may capture an image to only be transmitted to the portable terminal 6 (or to the management server 4 so that the user can view the image on the portable terminal 6). This is because the user may have different preferences for an image to be printed on a sticker sheet and an image to be transmitted to the portable terminal 6. The photograph sticker creating apparatus 1 realizes the user's intention of capturing an image to be transmitted to the portable terminal 6.

After finishing a photography control, the user moves out of the photography space A1 either through the entrance G1 into an edit space A2-1 as indicated by the hollow arrow #3 or through the entrance G2 into an edit space A2-2 as indicated by the hollow arrow #4.

The edit space A2-1 is an edit space on the front-surface side of the editing section 12, whereas the edit space A2-2 is an edit space on the back-surface side of the editing section 12. The touch panel monitor of the photographing section 21, for example, displays a screen for guiding the user to either the edit space A2-1 or the edit space A2-2. The user is guided to, for example, an empty one of the two edit spaces as a destination. The user, after moving into the edit space A2-1 or the edit space A2-2, starts an edit control. A user in the edit space A2-1 and another user in the edit space A2-2 can simultaneously perform respective edit controls.

After the end of an edit control, the photograph sticker creating apparatus 1 starts printing a selected one(s) of the images (which may have been edited). While the selected image(s) is being printed, the user, after finishing an edit control, (i) moves out of the edit space A2-1 into a post-service space A3 as indicated by the hollow arrow #5 in the case where the user has performed an edit control in the edit space A2-1, (ii) receives a post-service in the post-service space A3, and (iii) performs an operation for that post-service. Alternatively, while the selected image(s) is being printed, the user, after finishing an edit control, (i) moves out of the edit space A2-2 into the post-service space A3 as indicated by the hollow arrow #6 in the case where the user has performed an edit control in the edit space A2-2, (ii) receives a post-service in the post-service space A3, and (iii) performs an operation for that post-service.

After the end of the image printing, the user receives a sticker sheet from the discharge opening of the post-service section 13 to end a series of operations for the photograph sticker creating game.

(Arrangements of Individual Members)

The description below deals with respective arrangements of the individual members included in the photograph sticker creating apparatus 1.

(Photographing Section 21)

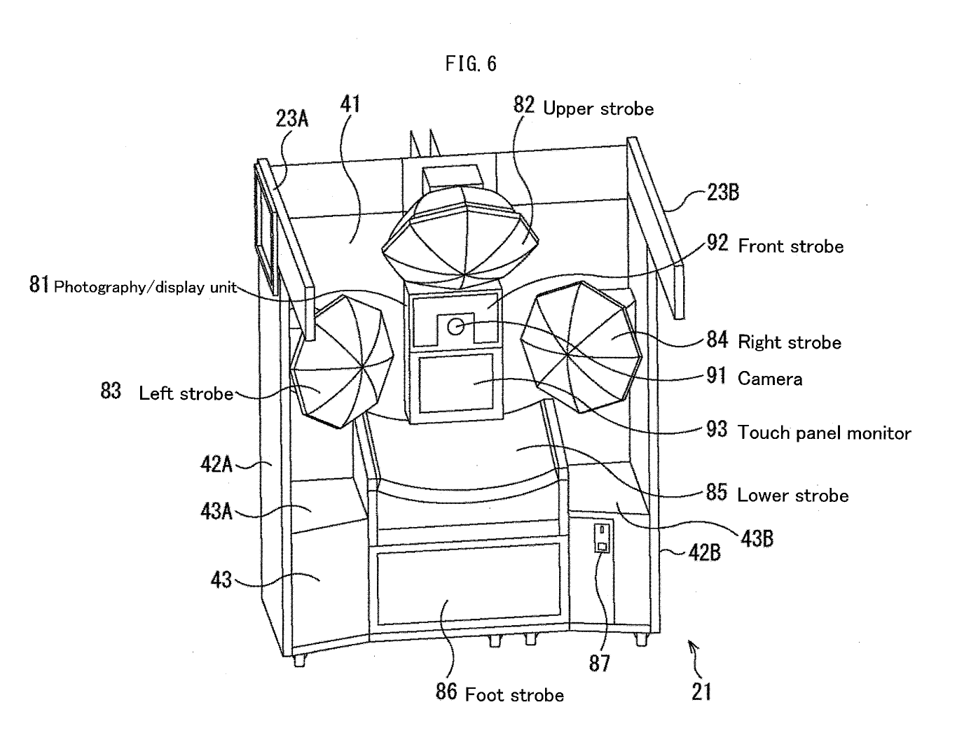

FIG. 6 is a diagram illustrating an example configuration of the photographing section 21 included in the photograph sticker creating apparatus 1. The photographing section 21 includes a front panel 41, a side panel 42A, a side panel 42B, and a box-shaped base section 43, the front panel 41, the side panel 42A, and the side panel 42B being attached to the base section 43.

The front panel 41 is so positioned as to face a user who is in the photography space A1 and who is performing a photography control. The side panel 42A is positioned to the left of the user who is in the photography space A1 and who is performing a photography control. The side panel 42B is positioned to the right of the user who is in the photography space A1 and who is performing a photography control. The photographing section 21 further includes (i) a connecting section 23A fixed to an upper portion of the side panel 42A and (ii) a connecting section 23B fixed to an upper portion of the side panel 42B.

The photographing section 21 includes a photography/display unit 81 at a substantially central portion of the front panel 41. The photography/display unit 81 includes a camera 91, a front strobe 92, and a touch panel monitor 93.

The camera 91 (i) includes an image sensing element such as a charge coupled device (CCD) or a complementary metal-oxide semiconductor (CMOS) and (ii) captures images of the user present in the photography space A1. The camera 91 obtains a moving image, which is then displayed on the touch panel monitor 93 in real time. The camera 91 captures an image at predetermined timing (for example, upon receipt of the user's instruction to capture an image), which image is then saved as a still image.

The touch panel monitor 93, located under the camera 91, includes (i) a monitor such as a liquid crystal display (LCD) and (ii) a touch panel disposed thereon. The touch panel monitor 93 has (i) a function as a live-view monitor for displaying a moving image obtained by the camera 91 and (ii) a function of displaying various graphical user interface (GUI) images and accepting the user's selection operation by means of the touch panel. The touch panel monitor 93 displays as appropriate a moving image as composited with an image such as a background image.

The photographing section 21 includes, installed on the front panel 41, (i) an upper strobe 82 over the photography/display unit 81, (ii) a left strobe 83 to the left of the photography/display unit 81, and (iii) a right strobe 84 to the right of the photography/display unit 81. The photographing section 21 further includes, under the photography/display unit 81, a lower strobe 85 on a projection of a portion of an upper surface of the base section 43.

The upper strobe 82 emits light from an upper position toward the front of the user. The left strobe 83 emits light toward the user from a position diagonally in front of and to the left of the user. The right strobe 84 emits light toward the user from a position diagonally in front of and to the right of the user. The lower strobe 85 emits light from a lower position toward the front of the user.

The photographing section 21 also includes, at the base section 43, a foot strobe 86 for emitting light toward the feet of the user. The upper strobe 82, the left strobe 83, the right strobe 84, the lower strobe 85, and the foot strobe 86 each contain a fluorescent lamp. These fluorescent lamps combine with the fluorescent lamp inside the strobe of the ceiling strobe unit 24 for use as lighting for the photography space A1. The photographing section 21 appropriately adjusts, by, as described below, (i) adjusting the respective amounts of light emitted by the individual fluorescent lamps or (ii) adjusting the number of fluorescent lamps emitting light, the brightness inside the photography space A1 in correspondence with a photography control that the user is performing.

The base section 43 has, to the right of the foot strobe 86, a coin insertion/return slot 87 into which the user puts money.

The photographing section 21 has spaces 43A and 43B to the left and right, respectively, of the lower strobe 85 at the upper surface of the base section 43. These spaces 43A and 43B are each used as a space in which the user who is to perform a photography control can place baggage such as hand baggage.

The photographing section 21 also includes a loudspeaker at, for example, a portion of the front panel 41 which portion is near the ceiling. The loudspeaker outputs sound such as a guidance voice, background music, and sound effects during a photography control.

(Background Section 22)

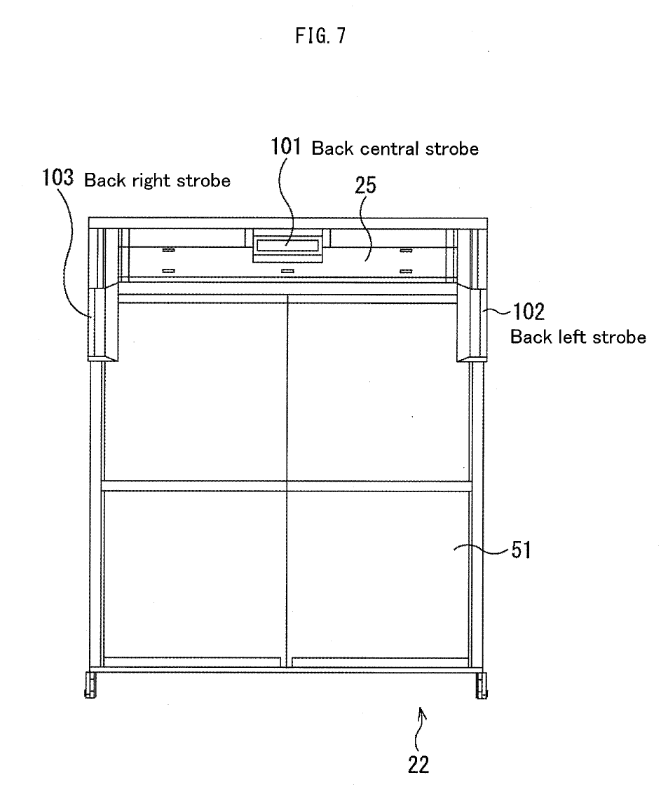

FIG. 7 is a diagram illustrating an example configuration of the background section 22 included in the photograph sticker creating apparatus 1. As described above, the back panel 51 is provided with a background curtain unit 25 at an upper portion thereof. The background section 22 includes, attached to a substantially central portion of the background curtain unit 25, a back central strobe 101 for emitting light from a central position toward the back of the user who is in the photography space A1 and who is performing a photography control.

The background section 22 includes, attached to an upper portion of the back panel 51 which upper portion is close to the entrance G1, a back left strobe 102 for emitting light toward the user from a position diagonally behind and to the left of the user who is in the photography space A1 and who is performing a photography control. The background section 22 further includes, attached to an upper portion of the back panel 51 which upper portion is close to the entrance G2, a back right strobe 103 for emitting light toward the user from a position diagonally behind and to the right of the user who is in the photography space A1 and who is performing a photography control.

(Editing Section 12)

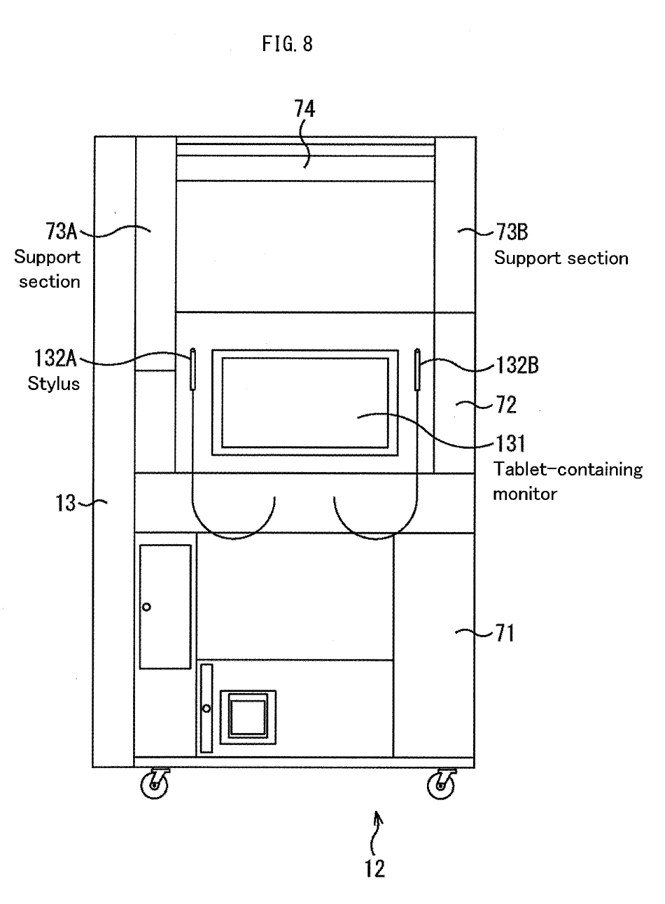

FIG. 8 is a diagram illustrating an example configuration of the editing section 12 included in the photograph sticker creating apparatus 1. The editing section 12, as illustrated in FIG. 8, includes a tablet-containing monitor 131 at a substantially central portion of the inclined surface 72. The inclined surface 72 is provided with (i) a stylus 132A to the left of the tablet-containing monitor 131 and (ii) a stylus 132B to the right of the tablet-containing monitor 131.

The tablet-containing monitor 131 includes (i) a monitor such as an LCD and (ii) a tablet terminal capable of being operated with use of the styluses 132A and 132B for an input, the tablet terminal overlying the monitor. The tablet-containing monitor 131 displays, for example, an edit screen that allows the user to edit an image selected for an edit. In the case where two users simultaneously edit an image, one user uses the stylus 132A, whereas the other user uses the stylus 132B.

The user, during an edit control, edits an image on the edit screen as if to write graffiti. The user can edit an image in various manners: for example, (i) a pen input for writing graffiti with a stylus in any of various line types and colors, (ii) a stamp input for inserting a stamp having any of various shapes (for example, the shape of a heart or petals) or showing any of various messages, (iii) a background operation for drawing a design on the background or the like, and (iv) a name stamp function for inserting a stamp showing a name entered. The user can edit an image with use of, for example, other functions including (i) a cosmetic function for a makeup simulation, (ii) a face fine-adjustment function for finely adjusting the size and/or shape of the eyes, the facial contour and the like, and (iii) a date stamp function for inserting an anniversary date or today's date.

The user, when editing an image at the editing section 12, does not necessarily edit an image to be printed. The user may edit an image to only be transmitted to the portable terminal 6 (that is, an image to not be printed). This is because the user may have different preferences for an image to be printed on a sticker sheet and for an image to be transmitted to the portable terminal 6 for use on a website. The photograph sticker creating apparatus 1 realizes the user's intention of, for instance, editing an image or the like for use in a blog or the like differently from an image to be printed on a sticker sheet.

(Post-Service Section 13)

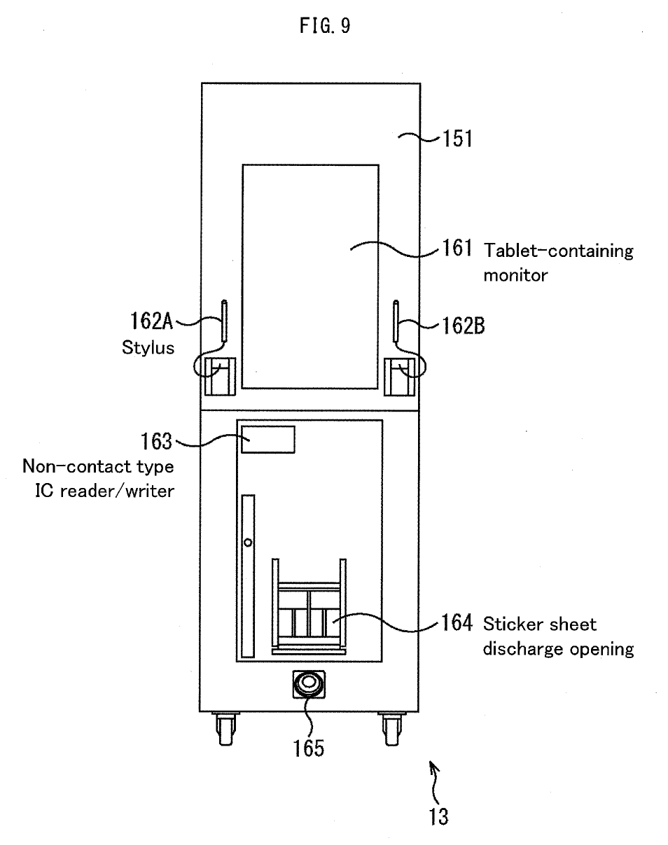

The post-service section 13 is disposed to the left of the editing section 12. FIG. 9 is a diagram illustrating an example configuration of the post-service section 13 included in the photograph sticker creating apparatus 1.

The post-service section 13 includes a tablet-containing monitor 161 at an upper central portion thereof. The post-service section 13 is provided with (i) a stylus 162A to the left of the tablet-containing monitor 161 and (ii) a stylus 162B to the right of the tablet-containing monitor 161. The tablet-containing monitor 161, similarly to the tablet-containing monitor 131, includes (i) a monitor such as an LCD and (ii) a tablet terminal capable of being operated with use of the styluses 162A and 162B for an input, the tablet terminal overlying the monitor. The tablet-containing monitor 161 displays a screen for use during a post-service step such as a simple game.

The post-service section 13 includes (i) a non-contact type IC reader/writer 163 under the tablet-containing monitor 161, (ii) a sticker sheet discharge opening 164 under the non-contact type IC reader/writer 163, and (iii) a loudspeaker 165 under the sticker sheet discharge opening 164.

The non-contact type IC reader/writer 163 communicates with a non-contact type IC brought close thereto, and thus reads data from or writes data into the non-contact type IC.

The sticker sheet discharge opening 164 discharges (i) a sticker sheet having, printed thereon, an image(s) created through an edit control by the user in the edit space A2-1 or (ii) a sticker sheet having, printed thereon, an image(s) created through an edit control by the user in the edit space A2-2. The image printing is performed by a printer contained in the editing section 12.

The loudspeaker 165 outputs sound such as a guidance voice, background music, and sound effects during a post-service.

(Internal Arrangement of Photograph Sticker Creating Apparatus 1)

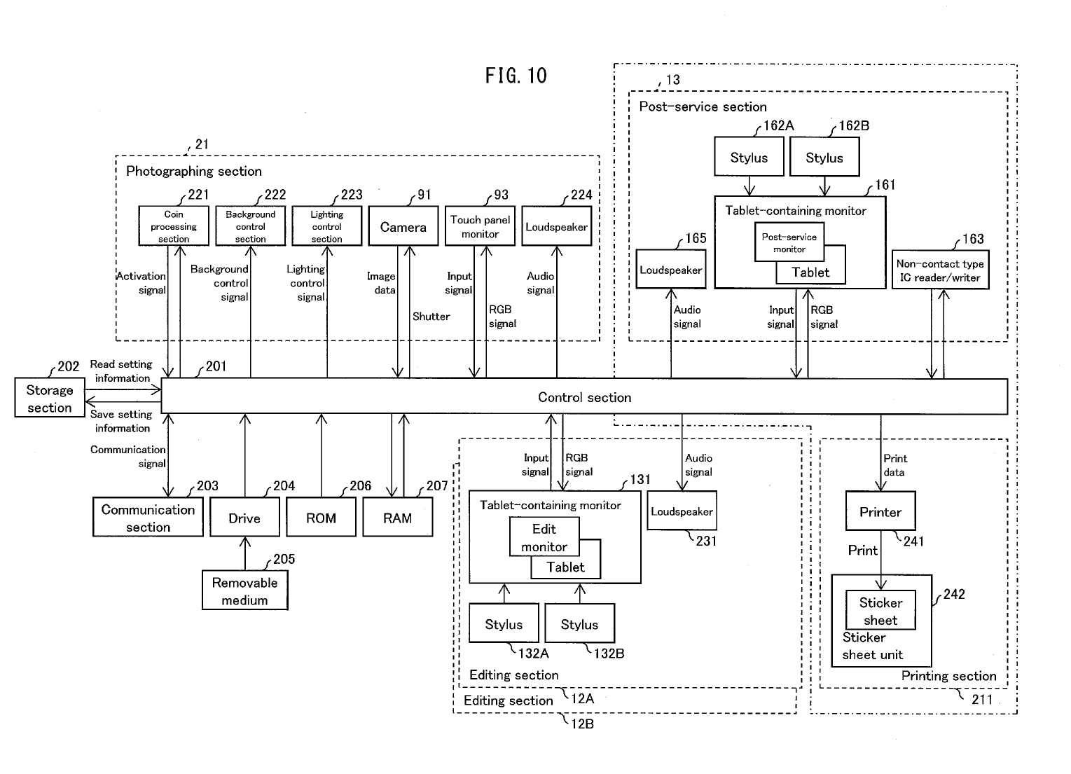

The description below deals with an internal arrangement of the photograph sticker creating apparatus 1. FIG. 10 is a block diagram illustrating an example internal configuration of the photograph sticker creating apparatus 1. Note that any member in FIG. 10 that is identical to a member described above is assigned a common reference numeral. Further, redundant descriptions are avoided below as appropriate.

The control section 201 includes, for example, a central processing unit (CPU). The control section 201 executes programs stored in a read only memory (ROM) 206 or a storage section 202, and thus controls an overall operation of the photograph sticker creating apparatus 1. The control section 201 is connected to a storage section 202, a communication section 203, a drive 204, a ROM 206, and a random access memory (RAM) 207. The control section 201 is further connected to the photographing section 21, the editing section 12, the post-service section 13, and a printing section 211.

The storage section 202 includes a nonvolatile storage medium such as a hard disk or a flash memory. The storage section 202 stores various setting information items supplied by the control section 201. Such information stored in the storage section 202 is read by the control section 201 as appropriate.

The communication section 203 serves as an interface with a network such as the Internet. The communication section 203 communicates with an external device under the control by the control section 201.

The drive 204 is a device to which a removable medium 205 including an optical disk, a semiconductor memory or the like is attached as appropriate. The drive 204 reads from the removable medium 205 computer programs and data to be supplied to the control section 201. Such computer programs are installed in the storage section 202, while such data is stored therein.

The ROM 206 stores programs to be executed by the control section 201 and data to be used by the control section 201. The RAM 207 temporarily stores programs executed by the control section 201 and data processed by the control section 201.

The photographing section 21 performs processes involved with a photography control by a user in the photography space A1. The photographing section 21 includes a coin processing section 221, a background control section 222, a lighting control section 223, a camera 91, a touch panel monitor 93, and a loudspeaker 224.

The coin processing section 221 detects an insertion of a coin into the coin insertion/return slot 87. The coin processing section 221, upon detection of an insertion of coins worth a predetermined amount of money such as 300 yen, supplies an activation signal indicative of that insertion to the control section 201.

The background control section 222, in response to a background control signal supplied by the control section 201, draws up or down a background curtain of the background curtain unit 25. The photograph sticker creating apparatus 1 may be arranged such that the user manually selects a desired background curtain.

The lighting control section 223 controls light emissions by the individual strobes in the photography space A1 in response to a lighting control signal supplied by the control section 201. As described above, the photography space A1 is provided with not only the strobe in the ceiling strobe unit 24 but also (i) the upper strobe 82, the left strobe 83, the right strobe 84, the lower strobe 85, and the foot strobe 86 of the photographing section 21 and (ii) the back central strobe 101, the back left strobe 102, and the back right strobe 103 of the background section 22. These strobes each also contain a fluorescent lamp.

Further, the lighting control section 223 adjusts, by (i) adjusting the respective amounts of light emitted by the fluorescent lamps in the respective strobes or (ii) adjusting the number of fluorescent lamps emitting light, the brightness inside the photography space A1 in correspondence with the stage of a photography control that the user is performing. The camera 91 captures an image under the control by the control section 201 and supplies such a captured image (image) to the control section 201.

The editing section 12 includes an editing section 12A that performs processes involved with an edit control by a user in the edit space A2-1. The editing section 12A includes a tablet-containing monitor 131, styluses 132A and 132B, and a loudspeaker 231 on the front-surface side of the editing section 12. The editing section 12 further includes an editing section 12B, which is identical in arrangement to the editing section 12A and which performs processes involved with an edit control by a user in the edit space A2-2.

The tablet-containing monitor 131 displays an edit screen under the control by the control section 201 and detects an operation by the user on the edit screen. The tablet-containing monitor 131 supplies, to the control section 201, a signal indicative of the operation by the user. This allows the user to edit a desired image.

The post-service section 13 performs processes involved with a post-service in the post-service space A3. The post-service section 13 includes a tablet-containing monitor 161, styluses 162A and 162B, a non-contact type IC reader/writer 163, and a loudspeaker 165.

The printing section 211 includes (i) a printer 241 for performing a print control and (ii) a sticker sheet unit 242. The printer 241 prints, onto a sticker sheet encased in the sticker sheet unit 242 attached to the printer 241, an image(s) as captured or an image(s) as edited through an edit control by the user, and discharges that sticker sheet from a sticker sheet discharge opening 164. FIG. 10 shows a dotted-and-dashed line surrounding the post-service section 13 and the printing section 211 to indicate those members which perform processes involved with a post-service for the user in the post-service space A3.

The printing section 211 may, during a process for a print control, not only print a captured image(s) (or an edited image(s)) onto a sticker sheet but also print in a margin of the sticker sheet (for example, at an edge of the sticker sheet) a uniform resource locater (URL), a sticker ID (that is, an ID for obtaining an image) and the like for obtaining an image having been transmitted to the management server 4. A sticker ID is an identifier that uniquely identifies one or more images (including images as captured and images as edited) generated in a single play at the photograph sticker creating apparatus 1, and is an identifier for the user to obtain an image(s) generated in a single play. The user can access the resource indicated by the URL for obtaining an image and enter the sticker ID to cause the portable terminal 6 to display a web page for obtaining an image(s) generated in a single game at the photograph sticker creating apparatus 1.

The above arrangement achieves the following advantage: For instance, in the case where the post-service section 13, when accepting an email address entry by the user, has failed to accept a correct email address due to time-out or typing error and is unable to transmit, to the user, information on, for example, a URL for obtaining an image, the user can access the resource indicated by the URL printed on the sticker sheet and enter the sticker ID to obtain an image.

The printing section 211 may alternatively print not a URL but a predetermined email address, a QR code (registered trademark) or the like as information for obtaining an image. In the case where a predetermined email address is printed on a sticker sheet, the user can transmit a blank email to the predetermined email address to receive from the management server 4 an email including a URL for obtaining an image. In the case where a QR code is printed on a sticker sheet, the user can use a portable terminal 6 to access the web page indicated by the QR code. The user can, in this case, directly access the web page for obtaining an image.

(Arrangement of Control Section)

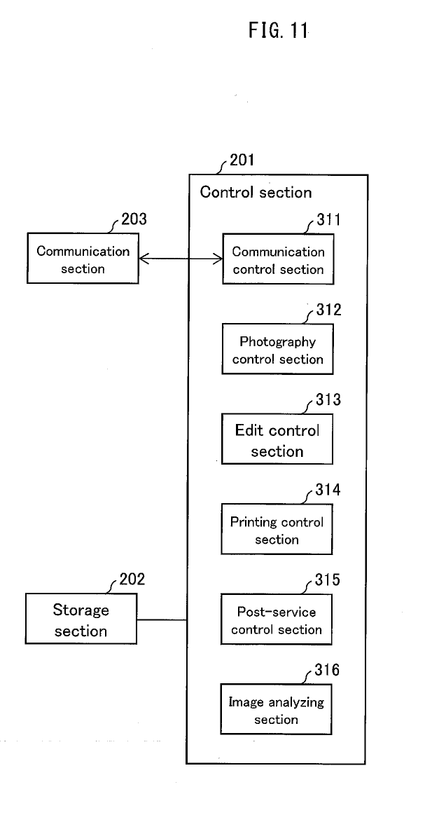

FIG. 11 is a functional block diagram illustrating a detailed example configuration of the control section 201 included in the photograph sticker creating apparatus 1. The control section 201, as illustrated in FIG. 11, includes a communication control section 311, a photography control section 312, an edit control section 313, a printing control section 314, and a post-service control section 315.

The communication control section 311 controls communication by the communication section 203 with an external device. The communication control section 311 (i) associates, with an image ID, an image that the user has selected to be saved onto an image providing website and (ii) transmits, to the management server 4, the image and the image ID associated with each other. The communication control section 311 may alternatively (i) further associate such an image (which the user has selected to be saved onto an image providing website) with information such as date-and-time information, an apparatus ID, edit information, person information, appearance information, shape information, photography part information (part information), photography angle-of-view information, occupying area information, operation information indicative of an operation having been performed at the photograph sticker creating apparatus, and event information and (ii) transmit, to the management server 4, the image, the image ID, and such additional information associated with one another.

An image ID refers to information that uniquely identifies an image. Date-and-time information refers to information indicative of the date and time at which the image was captured. An apparatus ID refers to information that uniquely identifies a photograph sticker creating apparatus 1 at which the image has been captured. Edit information refers to information indicative of an edit to the image, that is, how the image has been composited by the user. Person information refers to information indicative of a person captured in the image (for example, the person's name or member ID). Appearance information refers to information indicative of the appearance of the user captured in the image (for example, clothes, ornaments such as an accessory, belongings such as a bag, nail art, and makeup). Shape information refers to information indicative of the shape of the image. Examples of the shape of an image include (i) image shapes different from one another in aspect ratio such as a square, a portrait image, and a landscape image and (ii) an image shape with rounded corners. Shape information includes information (collage information) on an image composited with a plurality of captured images as in a collage, the information indicating the number of captured images composited with one another. Collage information is, for example, information including, as illustrated in FIG. 21, (i) the number of captured images included in the composite image and (ii) the respective image IDs of the captured images. Photography part information refers to information (for example, information indicative of “whole body”, “close-up” or the like) indicative of a part of the user (or an object) captured in the image. Photography angle-of-view information refers to information indicative of the angle of view at which the image has been captured. Photography angle-of-view information is, for example, information indicative of (i) whether the image is a so-called obliquely captured image such as an image captured with a camera inclined at an angle or a slightly obliquely trimmed image and (ii) the angle of that image. Occupying area information refers to information indicative of the area that an object occupies in the image. Operation information indicative of an operation having been performed at the photograph sticker creating apparatus includes information such as (i) photography course information indicative of the photography course that the user selected when capturing the image at the photograph sticker creating apparatus 1, (ii) name information indicative of the name of a name stamp that the user put over the image when editing the image at the photograph sticker creating apparatus 1, and (iii) sticker layout information indicative of the sticker layout that the user selected when printing a sticker at the photograph sticker creating apparatus 1. Event information refers to information indicative of an event related to the image. For instance, in the case where the user selected a course (for example, a course for Christmas, Halloween, New Year's Day, a school entrance ceremony, a commencement ceremony, Valentine's Day, or birthday) before capturing an image, event information indicative of the course selected may be added to the image captured. Event information corresponding to a stamp(s) used or a character(s) inserted in editing the image may be added to the image. Further, in the case where the user selected (inputted) a trigger (reason) for the play during a post-service or on a portable terminal 6, event information indicative of that reason inputted may be added to the image.

The photograph sticker creating apparatus 1 generates three types of images: (1) a captured image that the photography control section 312 obtains from the camera 91, (2) a corrected image generated by the photography control section 312 correcting a captured image, and (3) an edited image generated by the edit control section 313 editing a captured image or corrected image on the basis of an operation by the user. The description herein refers to the captured image, the corrected image, and the edited image collectively as a generated image. The captured image is, stated differently, an image captured by the camera 91. The corrected image refers to an image showing a person with, for example, a facial part corrected by the photography control section 312. More specifically, the corrected image refers to an image showing a person with the eyes corrected in size, the face corrected in size (face size reduction process), any other part corrected in size, or any part corrected in color or the like. The edited image refers to, for example, an image having been subjected to a graffiti edit process, that is, an image which has been composited with another image such as an image of a frame background, to which a stamp image or image drawn with a stylus has been added, and/or which has been subjected to a color correction or the like.

The communication control section 311 transmits, to the management server 4, at least one of a captured image, a corrected image, and an edited image.

The photography control section 312 controls (i) a process performed by the photographing section 21 in relation to money that the user inserts to start a photograph sticker creating game and (ii) a process performed by the photographing section 21 in relation to a photography control that the user performs during a photograph sticker creating game, for example, a process of capturing an image of a user group under a photography control by the user. The photography control section 312 is also capable of generating an image ID and date-and-time information. The photography control section 312 may be arranged to, in the case where the user has selected a photography course, generate event information indicative of the course that the user has selected.

The edit control section 313 controls processes involved with an edit control by the user during a photograph sticker creating game, for example, a process performed by the editing sections 12A and 12B of editing an image by writing graffiti thereon. The edit control section 313 may be arranged to generate edit information for each image. For instance, the edit control section 313 may generate, as edit information, information indicative of the type of a stamp, a background image, and/or a frame (foreground image) with which the user has composited the image (that is, stamp information, background information, and frame information). The edit control section 313 may generate, on the basis of, for example, the path of an input and a character(s) used in a name stamp and/or message stamp, character-string information as edit information which character-string information indicates a character string with which the user has composited the image. The edit control section 313 may generate color-tone correction information as edit information which color-tone correction information indicates a color-tone correction process performed on the image (to produce, for example, a monochrome image or a sepia-tone image). Edit information is, in other words, information including at least one of stamp information, background information, frame information, character-string information, color-tone correction information and the like. The edit control section 313 may be arranged to (i) identify an event corresponding to a stamp(s), a character(s) and/or the like with which the user has composited the image and (ii) generate event information indicative of the event identified.

The printing control section 314 controls processes involved with a printing control by the user during a photograph sticker creating game, for example, a process performed by the printing section 211 of printing a sticker sheet.

The post-service control section 315 controls processes involved with a post-service during a photograph sticker creating game, for example, a process performed by the post-service section 13 of attending to a user group who has finished editing an image(s).

The post-service control section 315 may generate information such as edit information, person information, appearance information, shape information, photography part information, and event information on the basis of information entered by the user during a post-service step. This will be described later in detail.

The control section 201 may further include, as illustrated in FIG. 11, an image analyzing section 316 for analyzing an image. The image analyzing section 316 may analyze an edited image to generate edit information. The image analyzing section 316 may analyze a captured image to identify the angle-of-view at which the image has been captured and to thus generate photography angle-of-view information. The image analyzing section 316 may analyze a captured image to identify the area that an object occupies in the image and to thus generate occupying area information. The image analyzing section 316 may (i) analyze a facial part of a person captured in the image, (ii) identify the facial expression of the person in the image through a process of determining a facial expression in an image with reference to a predetermined image information database, and (iii) thus generate facial expression information indicative of a facial expression such as a smiling face or tearful face.

(Management Server 4)

The description below deals in detail with the management server 4 with reference to FIG. 1. FIG. 1 is a block diagram illustrating a main part of the management server 4 of Embodiment 1 of the present invention. The management server 4, as illustrated in FIG. 1, includes a control section 401, a storage section 402, and a communication section 403 as main components. The control section 401 centrally controls the individual members included in the management server 4. The storage section 402 stores various pieces of data for use in the management server 4. The communication section 403 communicates with other devices included in the captured-image management system 10.

(Details of Control Section 401)

The control section 401, as illustrated in FIG. 1, includes a communication control section 411, an email creating section 412, a web page creating section (page creating section) 413, and an image management section 414.

(Communication Control Section 411)

The communication control section 411 controls communication by the communication section 403.

(Email Creating Section 412)

The email creating section 412 creates an email to be transmitted to an email address of a user who has played a game at the photograph sticker creating apparatus 1. The email creating section 412 of the present embodiment (i) creates, with reference to data stored in an email database 421, an email that prompts a user to save an image(s) and that is to be transmitted to an email address supplied from the communication control section 411 and (ii) supplies that email to the communication control section 411.

(Webpage Creating Section 413)

The web page creating section 413 creates a web page to be displayed on the portable terminal 6. The web page creating section 413 of the present embodiment (i) creates, with reference to data stored in a web page database 423 and data stored in an image database 424, a web page responding to an access request received from the portable terminal 6 and (ii) supplies that web page to the communication control section 411. The web page creating section 413 creates a web page corresponding to the member status of the user (described later in detail).

Specifically, the web page creating section 413 creates an image-list page that allows the portable terminal 6 to display a plurality of images stored in the image database 424. More specifically, the web page creating section 413 creates, for each member ID (that is, each requesting user), an image-list page for displaying images associated with that member ID.

The image-list page includes a plurality of album pages that are selectable for display with use of tabs or the like. The web page creating section 413 sorts a plurality of images, stored in the image database 424, into types on the basis of image management information described below and shows the plurality of images on the plurality of album pages for the respective types. Stated differently, the web page creating section 413 extracts, from a plurality of images stored in the image database 424, images with an identical attribute on the basis of image management information described below and shows those images with an identical attribute on an album page to eventually create a plurality of album pages for the respective attributes.

The web page creating section 413 may create, for example, an album page including, among the plurality of images, images of a certain shape (for example, images for a social networking service (SNS) or images for a portable terminal). The web page creating section 413 may create an album page including, among the plurality of images, images captured of a certain part of the user (for example, whole-body images or close-up images). The web page creating section 413 may create an album page including, among the plurality of images, images with a certain edit performed by the photograph sticker creating apparatus 1 (for example, writing a character(s), inserting a stamp(s) or a frame(s)). The web page creating section 413 may create an album page including, among the plurality of images, images captured of the user having a certain appearance. The web page creating section 413 may create an album page including, among the plurality of images, images captured at a certain date and time or during a certain period. The web page creating section 413 may create an album page including, among the plurality of images, images captured by a certain apparatus model of photograph sticker creating apparatus 1. The web page creating section 413 may create an album page including, among the plurality of images, images captured of a certain person. The web page creating section 413 may create an album page including, among the plurality of images, images related to a certain event (for example, Christmas, Halloween, New Year's Day, a school entrance ceremony, a commencement ceremony, or Valentine's Day). The web page creating section 413 may create an album page including, among the plurality of images, images of a certain source.

The web page creating section 413 may create an album page including images captured of a certain person with a certain background image. The web page creating section 413 can, in other words, (i) sort images into types on the basis of one or more information items included in the image management information and (ii) display a plurality of album pages for the respective types. Sorting images on the basis of one or more information items as such can improve the user's performance of retrieving an image.

The web page creating section 413 may create, only for a user as a paid member, an image-list page including a plurality of tab-selectable album pages. In other words, the management server 4 may provide, only for a user having particular member status (for example, only for a user as a paid member), a service of sorting images for different purposes.

The web page creating section 413 may, instead of showing on an image-list page a generated image(s) as generated by the photograph sticker creating apparatus 1 (that is, without processing such a generated image(s)), extract only a face region of a person captured in the generated image and show an image of the face. In the case where a plurality of persons are captured in a generated image, the web page creating section 413 may extract, as a facial image, either (i) an image including respective face regions of all the plurality of persons or (ii) images each including one of the respective face regions of the plurality of persons (in other words, extract a plurality of facial images from a single generated image). This arrangement allows the user to view only (i) an image of the face of his or her own or (ii) a list of respective facial images of particular persons.

The web page creating section 413 may show images in a reduced size on an image-list page during a scroll operation by the user as compared to during a non-scroll operation (that is, during a static period in which the user is not performing a scroll operation). The web page creating section 413 can, for instance, (i) show images of a predetermined size on an image-list page during a static period and (ii) in the case where the user has performed a scroll operation, reduce the size of the images shown on the image-list page from the above predetermined size. This arrangement facilitates a scroll operation in the case where a large number of images are shown on an image-list page, and thus allows the user to easily retrieve a desired image.

The term “page” as used to describe the present invention refers to data (for example, a web page) that the management server 4 transmits to a communication terminal such as the portable terminal 6 for display thereon. Such a page typically includes text data and image data, and may additionally include audio data and/or moving image data.

(Image Management Section 414)

The image management section 414 manages images to be provided for the user through an image providing website. The image management section 414 of the present embodiment saves in the image database 424 an image(s), among images created by the photograph sticker creating apparatus 1, which has been selected by the user.

The image management section 414, when saving an image selected by the user, (i) generates image management information for managing that image and (ii) saves the image and the generated image management information in association with each other. The image management section 414 either refers to information transmitted from the photograph sticker creating apparatus 1 and associated with the image or automatically analyzes the image to generate image management information for the image. Image management information generated by the image management section 414 includes an image ID, date-and-time information, and an apparatus ID. Image management information may additionally include such information as edit information, person information, appearance information, shape information, event information, source information, photography part information, photography angle-of-view information, occupying area information, and operation information indicative of an operation having been performed at the photograph sticker creating apparatus. Image management information may be construed as image attribute information (tag information) indicative of an attribute(s) of the image.

FIG. 18 illustrates an example of image management information generated by the image management section 414. Image management information includes, as illustrated in FIG. 18, such items as “IMAGE ID”, “STAMP USE FLAG”, “CHARACTER-STRING INFORMATION”, “SHAPE INFORMATION”, “APPEARANCE INFORMATION”, “PHOTOGRAPHY PART INFORMATION”, “EVENT INFORMATION”, “PERSON INFORMATION”, “SOURCE INFORMATION”, “COLOR-TONE CORRECTION INFORMATION”, and operation information indicative of an operation having been performed at the photograph sticker creating apparatus.

The item “IMAGE ID” refers to the image ID associated with an image transmitted from the photograph sticker creating apparatus 1. In the example illustrated in FIG. 18, the item “IMAGE ID” includes, for each image captured, (i) a photography date and time at which the image was captured, (ii) an apparatus ID indicative of the photograph sticker creating apparatuses 1 by which the image was captured, and (iii) a serial number assigned to the image captured. The serial numbers are assigned successively to captured images. In other words, in the example illustrated in FIG. 18, the item “IMAGE ID” includes date-and-time information.

The image management section 414 may use, as date-and-time information, not a photography date and time but a date and time at which the image was saved onto the management server 4. In other words, the example illustrated in FIG. 18 may include a save date and time as part of the item “IMAGE ID”.

The item “STAMP USE FLAG” refers to information indicative of whether the individual stamps were used by the user in editing the image. The item “STAMP USE FLAG”, stated differently, refers to stamp information indicative of each stamp included in the image. The image management section 414 sets a stamp use flag(s) on the basis of edit information transmitted from the photograph sticker creating apparatus 1 and associated with the image. The image management section 414 may alternatively analyze the image to detect each stamp included in the image and to thus set a stamp use flag(s).

The item “CHARACTER-STRING INFORMATION” refers to, as described above, information indicative of a character string(s) written in the image by the user. The image management section 414 generates “character-string information” on the basis of edit information transmitted from the photograph sticker creating apparatus 1 and associated with the image. The image management section 414 may alternatively analyze any message stamp, name stamp or the like in the image to detect any character string written in the image and to thus generate character-string information. The image management section 414 may (i) generate, either on the basis of edit information or through an analysis of the image, not only a stamp use flag(s) and character-string information but also such information as frame information and/or background information and (ii) add such information to the image management information.

The item “SHAPE INFORMATION” refers to, as described above, information indicative of the shape of the image. The image management section 414 generates shape information on the basis of shape information transmitted from the photograph sticker creating apparatus 1 and associated with the image. The image management section 414 may alternatively analyze the image automatically to identify the shape of the image and to thus generate shape information.

The item “APPEARANCE INFORMATION” refers to, as described above, information indicative of the appearance of the user captured in the image (for example, clothes, ornaments such as an accessory, belongings such as a bag, nail art, and makeup). The image management section 414 generates appearance information on the basis of information entered by the user.

Appearance information is generated in response to the user's input. The user is presented with input areas for different information items, and is allowed to enter information as appropriate in any area available for an input. Since the image management section 414 cannot automatically create appearance information, the user enters, as information on clothes, shoes, an accessory bag, nail art or the like, information on the name of the item, the name of the brand, the name of the store of the purchase, the price, any note or the like.

The item “PHOTOGRAPHY PART INFORMATION” refers to, as described above, information indicative of a part of an object which part is captured in the image. The image management section 414 generates photography part information on the basis of photography part information transmitted from the photograph sticker creating apparatus 1 and associated with the image. The image management section 414 may alternatively analyze the image to set photography part information to (i) “WHOLE BODY” in the case where the image is an image captured of the whole body of a person (user) or to (ii) “CLOSE-UP” in the case where the image is a close-up image captured of the face of a person.

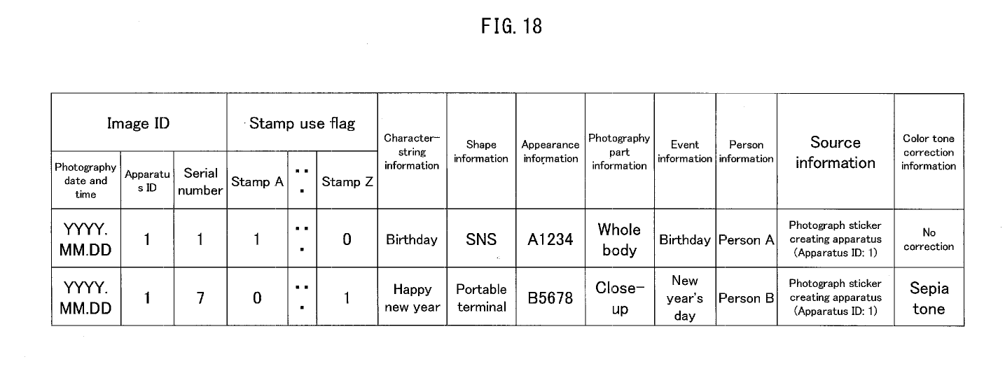

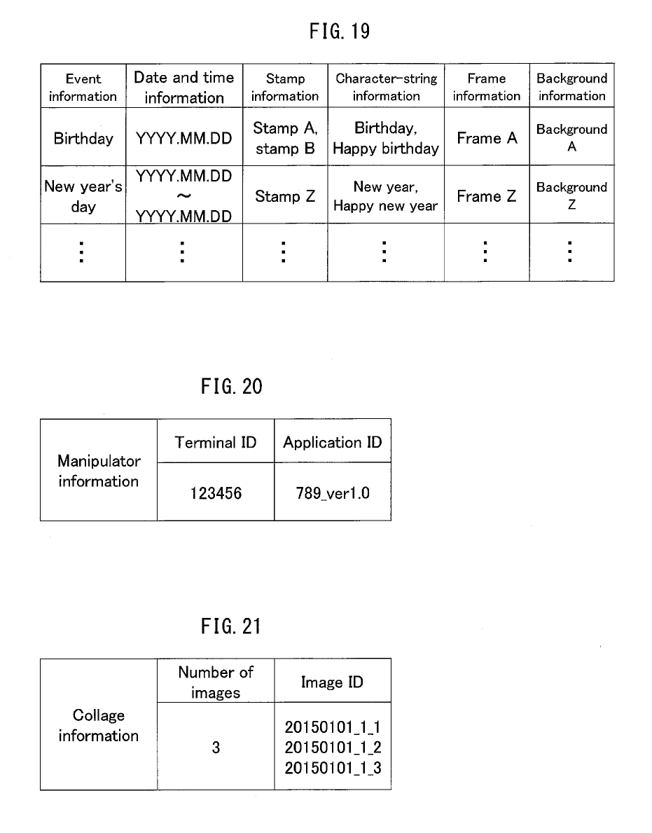

The item “EVENT INFORMATION” refers to, as described above, information indicative of an event related to the image. The image management section 414 refers to an event information correspondence table such as that illustrated in FIG. 19 to identify event information corresponding to such information associated with the image as date-and-time information or edit information and to thus generate event information for the image. The event information correspondence table illustrated in FIG. 19 is a mere example: The event information correspondence table may be any information defining correspondence between (i) such information as date-and-time information or edit information and (ii) event information.

The item “PERSON INFORMATION” refers to, as described above, information indicative of a person captured in the image (for example, the person's name or member ID). The image management section 414 generates person information on the basis of person information transmitted from the photograph sticker creating apparatus 1 and associated with the image. The image management section 414 may alternatively analyze the image to generate person information. In this case, the storage section 402 stores, in advance, such information as information that associates (i) information that identifies a person in the image, for example, person information (the person's name or member ID) with (ii) an image (reference image) captured of that person. The image management section 414 may further alternatively analyze the image to identify a person in the image on the basis of a character string written in the image.

The example illustrated in FIG. 18 includes, as person information, not information indicative of the user as the owner of the image but only information indicative of a person other than the user which person is captured in the image. Person information is, however, not limited to such information, and may include information indicative of a person including the user.

The item “SOURCE INFORMATION” refers to information indicative of the source of the image (for example, an apparatus from which the image has been transmitted or an apparatus, a website, or an application with which the image has been generated, manipulated, or edited). The image management section 414 sets source information to “PHOTOGRAPH STICKER CREATING APPARATUS” for an image transmitted from the photograph sticker creating apparatus 1. In this case, the image management section 414 may include, in the source information, the apparatus ID of the photograph sticker creating apparatus 1 illustrated in FIG. 18. The user can save, from the portable terminal 6 or the like onto the management server 4, an image other than an image generated by the photograph sticker creating apparatus 1. In the case where, for instance, the user has manipulated an image with use of an image manipulating application, the image manipulating application can associate, with that image, source information indicative of the source of the manipulated image (that is, manipulator information indicative of the section that has performed the manipulation process). The portable terminal 6, in this case, transmits, to the management server 4, the image associated with such source information. This allows the image management section 414 to generate source information on the basis of source information associated with the image. For instance, the portable terminal 6 transmits, to the management server 4 as source information, the manipulator information illustrated in FIG. 20. As illustrated in FIG. 20, manipulator information includes, for example, the terminal ID of the portable terminal 6 and the application ID of the image manipulating application used for the manipulation process.

The item “COLOR-TONE CORRECTION INFORMATION” refers to, as described above, information indicative of a color-tone correction process performed on the image (to produce, for example, a monochrome image or a sepia-tone image). The image management section 414 generates color-tone correction information on the basis of color-tone correction information transmitted from the photograph sticker creating apparatus 1 and associated with the image. The image management section 414 may alternatively analyze the image to generate color-tone correction information.

The image management section 414 may either refer to photography angle-of-view information and occupying area information both transmitted from the photograph sticker creating apparatus 1 and associated with the image or analyze the image to generate photography angle-of-view information and occupying area information and to thus include such photography angle-of-view information and occupying area information in the image management information. The image management section 414 may further generate operation information indicative of, for example, a photography course and/or sticker layout selected at the photograph sticker creating apparatus 1. The image management section 414 may further generate position information indicative of the position of the photograph sticker creating apparatus 1.

The image management section 414 may, in saving an image selected by the user, analyze the image to detect, for example, a face region or a body region in the image and to thus automatically change, on the basis of the result of the detection, the shape of the image to be saved. The image management section 414 may group image shapes for different uses. The image management section 414 may, for example, group icon images for an SNS or banner images for an SNS. Alternatively, the image management section 414 may roughly group images to only be transmitted to a portable terminal.

The image management section 414 may, in the case where the image database 424 stores a plurality of images of a substantially identical shape among a plurality of images of a certain user, arrange those images of a substantially identical shape to create a moving image (for example, a flip GIF animated cartoon). The image management section 414 may create a slide show that switches images of any shapes at predetermined intervals. In this case, the image management section 414 may create a moving image with use of images of a certain type as sorted above. The image management section 414 may, for example, sort images to group images created during a predetermined period (for example, during the past year) and create a moving image with use of those images gathered. The image management section 414 may, in creating a moving image, arrange that moving image so that it is capable of being shown while desired music is being played as appropriate as background music. The image management section 414 may, in that case, further arrange that moving image so that it is capable of being uploaded to a predetermined public moving-image website. The image management section 414 may also allow the user to save onto the portable terminal 6 a moving image created by the image management section 414. The image management section 414 may create a moving image either automatically or in response to an instruction by the user.

In the case where the image management section 414 has created a moving image, the image management section 414 may assigns, to the moving image, format information indicative of that moving image (for example, “GIF moving image”) to allow the user to view a list of such moving images created.

To sum up, the web page creating section 413 sorts a plurality of images, stored in the image database 424, into types on the basis of at least one of (i) image processing information indicative of a process having been performed on the plurality of images, (ii) object information indicative of the state of an object (or objects; the same applies herein) in at least one of the plurality of images, and (iii) operation information indicative of an operation having been performed at the photograph sticker creating apparatus and shows the plurality of images on a plurality of album pages for the respective types.

Image processing information refers to information indicative of a process that the photograph sticker creating apparatus 1, the management server 4, or the portable terminal 6 has performed on the image (for example, a process of changing the shape (size) or editing the image). Examples of image processing information include shape information, edit information, event information (corresponding to edit information), manipulator information, and collage information. Object information refers to information indicative of the state of an object(s) (for example, the user(s)) captured in the image. Examples of object information include person information, photography part information, appearance information, occupying area information, and photography angle-of-view information. Operation information indicative of an operation having been performed at the photograph sticker creating apparatus includes information such as (i) photography course information indicative of the photography course that the user selected when capturing the image at the photograph sticker creating apparatus 1, (ii) name information indicative of the name of a name stamp that the user put over the image when editing the image at the photograph sticker creating apparatus 1, and (iii) sticker layout information indicative of the sticker layout that the user selected when printing a sticker at the photograph sticker creating apparatus 1.

To define the process by the web page creating section 413 from a different viewpoint, the web page creating section 413 sorts a plurality of images, stored in the image database 424, into types on the basis of at least one of input information inputted by the user on the image and analysis information obtained through an analysis of the image and shows the plurality of images on a plurality of album pages for the respective types.

Input information refers to information that the user has inputted for an image through an operation of the photograph sticker creating apparatus 1 or the portable terminal 6. Examples of input information include edit information, shape information, appearance information, person information, event information, source information, photography part information, and operation information. Analysis information refers to information obtained through an analysis of an image by the photograph sticker creating apparatus 1, the management server 4, or the portable terminal 6. Examples of analysis information include edit information, person information, shape information, photography part information, event information, photography angle-of-view information, and occupying area information.

(Details of the Storage Section 402)

As illustrated in FIG. 1, the storage section 402 includes an email database 421, a member database 422, a web page database 423, and an image database 424.

(Email Database 421)

The email database 421 stores various data for creating an email to be transmitted to a terminal of a user.

(Member Database 422)

The member database 422 stores various items of information on users who are members of an image providing website. In the present embodiment, the member database 422 stores, on an individual user basis, information for identifying a user who uses the photograph sticker creating apparatus 1 (user identification information). The user identification information is information on a user including, for example, a member ID, an email address, a nickname, a birth date, an address, a member status, a sign-up date, and a terminal ID of a portable terminal owned by the user. Examples of the member status encompass a paid member and a free member.

(Web Page Database 423)

The web page database 423 stores various data for creating a web page of an image providing website to be displayed on the portable terminal 6.

(Image Database 424)

The image database 424 stores images instructed by the user to be saved on the image providing website, out of images captured of the user by the photograph sticker creating apparatus 1. The images stored in the image database 424 are grouped by individual user who is registered as a member in the member database 422.

The storage section 402 further includes a temporary storage database (not illustrated) for temporarily storing therein, for example, image data received from the photograph sticker creating apparatus 1.

(Details of Communication Section 403)

In the present embodiment, the photograph sticker creating apparatus 1 and the portable terminal 6 communicate with the communication section 403. Under control of the communication control section 411, the communication section 403 receives/transmits data from/to another device.

(Portable Terminal 6)

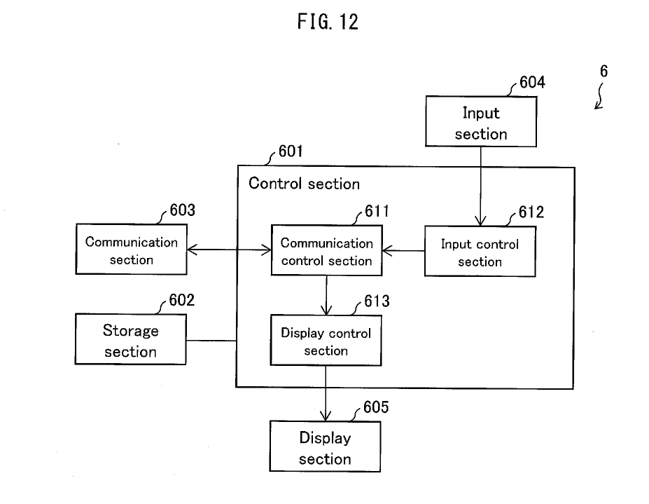

FIG. 12 is a block diagram illustrating a main part of a portable terminal 6 of Embodiment 1 of the present invention. As illustrated in FIG. 12, the portable terminal 6 includes, as main components, a control section 601, a storage section 602, a communication section 603, an input section 604, and a display section 605. The control section 601 centrally controls the components provided in the portable terminal 6. The storage section 602 stores various data to be used by the portable terminal 6. The portable terminal 6 communicates with the other constituent devices of the captured-image management system 10. The input section 604 is a device through which a user enters information into the portable terminal 6 and is, for example, a touch panel. The display section 605 is a device for displaying information thereon and is, for example, a liquid crystal display device.

(Details of Control Section 601)

As illustrated in FIG. 12, the control section 601 includes a communication control section 611, an input control section 612, and a display control section 613.

The communication control section 611 controls communication performed by the communication section 603. The input control section 612 controls information inputting of the input section 604. The display control section 613 controls information displaying of the display section 605. For example, upon receipt of a web page received from the communication control section 611, the display control section 613 outputs the web page to the display section 605, thereby causing the web page to be displayed on the display section 605.

(Member Registration Process)

The captured-image management system 10 allows a user who has registered himself or herself as a member of the image providing website to save a captured image onto the image providing website. The user follows a predetermined procedure to register himself or herself as a free member of the image providing website. The predetermined procedure will be described below with reference to FIG. 13. FIG. 13 is a screen flow diagram illustrating an example web page displayed on the display section 605 of the portable terminal 6 during the member registration process.

Through the use of the portable terminal 6, the user accesses the image providing website to register himself or herself as a member of the image providing website. Then, a top page 1001 (see (a) of FIG. 13) of the image providing website is displayed on the display section 605 of the portable terminal 6. The top page 1001 includes at least the following images: a link image 1002 for proceeding with a process of login as a member, and a link image 1003 for proceeding with a free member registration process.

By operating the input section 604 of the portable terminal 6, the user selects the link image 1003 for proceeding with the free member registration process. In response to the selection the user has made, the portable terminal 6 communicates with the management server 4 and then causes a web page 1011 for a free member registration (see (b) of FIG. 13) to be displayed on the display section 605.

The web page 1011 includes at least the followings: an entry form 1012 for entering information for identifying a user who is to be registered as a free member (user identification information); and a link image 1013 for transmitting the entered user identification information to the management server 4. By operating the input section 604 of the portable terminal 6, the user enters the user identification information in the entry form 1012. The user identification information includes various kinds of personal information of a user, such as a member ID, a password, and an email address. After completing the entry of the user identification information, the user selects the link image 1013. In response to the selection the user has made, the portable terminal 6 transmits the user identification information to the management server 4 and requests the management server 4 to register the user as a free member.

The communication control section 411 of the management server 4 receives, via the communication section 403, the user identification information having been transmitted from the portable terminal 6. The communication control section 411 outputs the user identification information thus received to the email creating section 412 and instructs the email creating section 412 to create an email for member registration. In response to the instruction, the email creating section 412 creates a member registration email 1021 (see (c) of FIG. 13). The member registration email 1021 is an email to be transmitted to an email address which is contained in the user identification information received from the communication control section 411. The member registration email 1021 contains a URL 1022 of a web page indicating the completion of the free member registration. The email creating section 412 outputs the member registration email 1021 to the communication control section 411. The communication control section 411 transmits the incoming member registration email 1021 to the email address of the user via the communication section 403.

Upon receipt of the member registration email 1021, the portable terminal 6 displays the member registration email 1021 on the display section 605. The user views the member registration email 1021 displayed on the display section 605 and then selects the URL 1022. In response to the selection the user has made, the portable terminal 6 requests the management server 4 for a web page specified by the URL 1022.

Upon receipt of the request, the management server 4 completes the free member registration. Specifically, the management server 4 creates an account region for the user (storage area for storing member-specific data) in the member database 422, and then saves the user identification information into the account region. At this time, the management server 4 additionally saves, into the account region, information indicating that the user is a free member. Finally, the management server 4 creates a web page indicating the completion of the free member registration and then transmits the web page thus created to the portable terminal 6.

Note that after the free member registration, the user can register himself or herself as a paid member of the image providing website by entering his/her member ID and password to log in to the image providing website and then going through a predetermined procedure. After the completion of the paid member registration, information indicating that the user is a paid member is additionally saved into the account region for the user.

(Flow of Service)

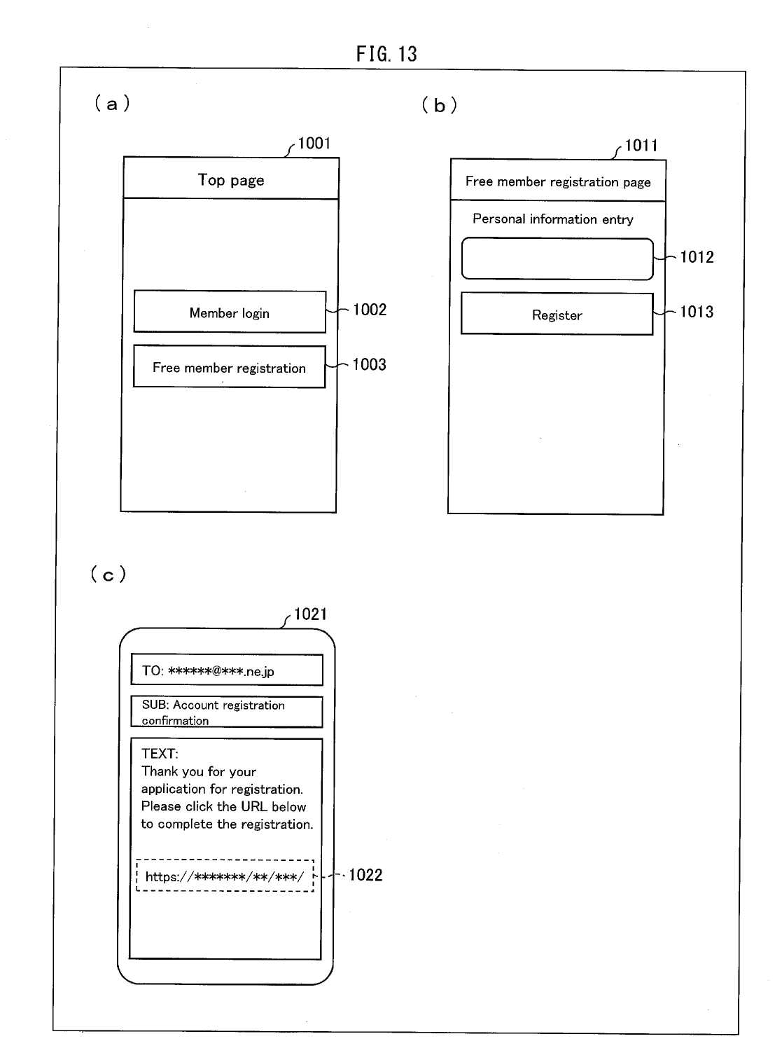

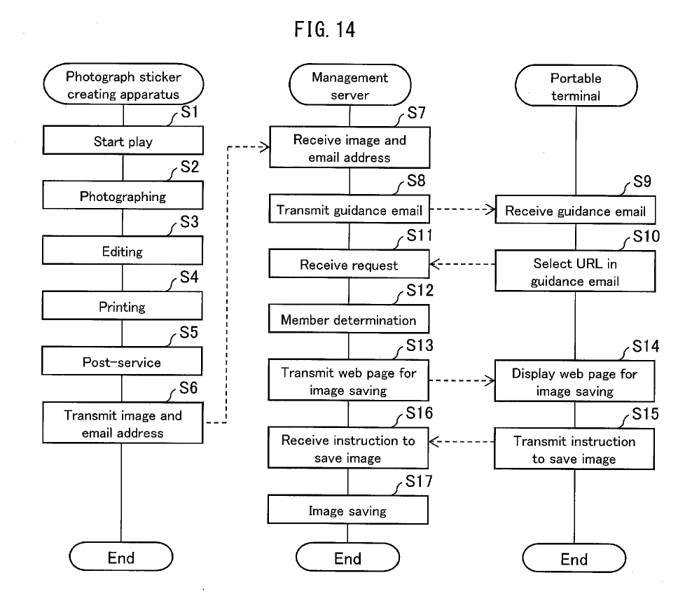

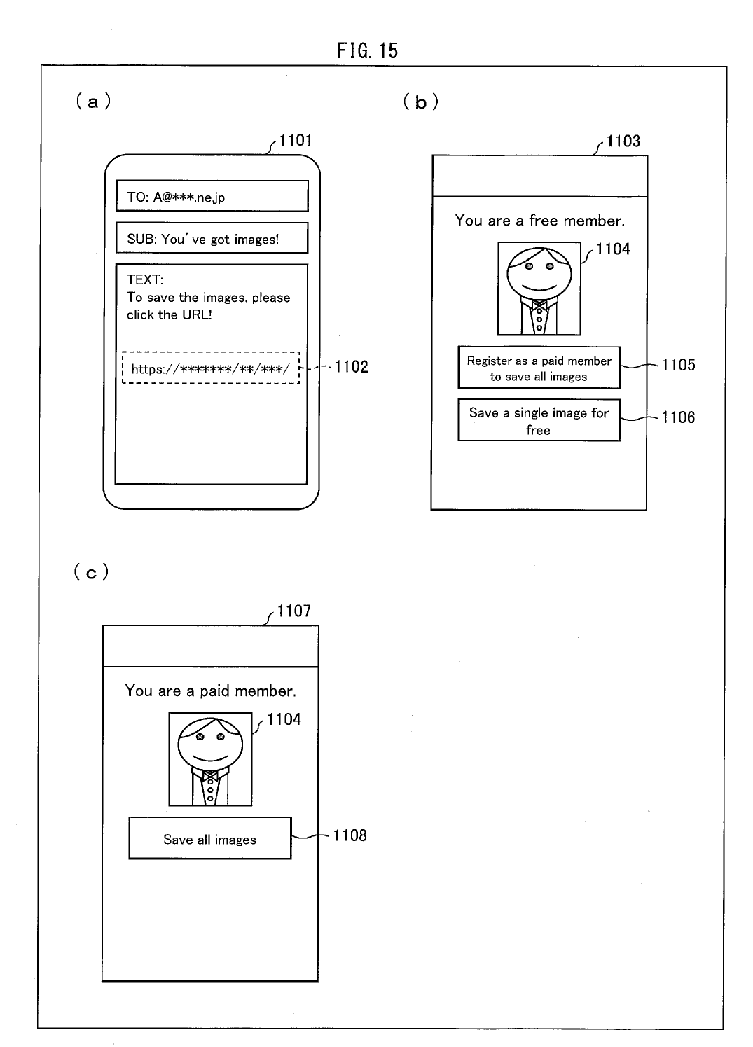

Next, the flow or a service provided by the captured-image management system 10 will be described in detail below with reference to FIGS. 14 and 15. FIG. 14 is a sequence diagram illustrating an example flow of a series of steps, covering from photographing to image saving, performed by the captured-image management system 10.

(Photographing)

As illustrated in FIG. 14, a user starts a play of a game with use of the photograph sticker creating apparatus 1 (step S1). Specifically, the user stands in front of the front panel 41 of the photograph sticker creating apparatus 1 and then inserts a coin(s) corresponding to a fee necessary for the play of the game into the coin insertion/return slot 87. The photography control section 312 determines whether or not a coin(s) worth a predetermined amount of money have been inserted, in accordance with a signal supplied from the coin processing section 221.

When determining that the coin(s) worth the predetermined amount of money has been inserted, the photography control section 312 controls the photographing section 21 so that a moving image of an object which image is obtained by the camera 91 is displayed in a live view on the touch panel monitor 93, and that photographing of the object, which is the user present in the photography space A1, is performed under the photography control performed by the user (step S2). Such a photography control is performed a plurality of times during a period of time for the photographing.

Note that the process performed under the photography control is not limited to the capture of an image to be printed on a sticker sheet and may be a predetermined number of photographings to capture an image to be transmitted to the portable terminal 6. In this arrangement, the image to be transmitted to the portable terminal 6, suitably (i) an image obtained by chroma key of images for composition and (ii) an image subjected to image processing such as color filter-based filtering, can be created during the photographing.

After the end of the photographing, the photography control section 312 guides the user who is present in the photography space A1 to move to the edit space A2-1 or the edit space A2-2. The guidance is performed by displaying a guidance screen on the touch panel monitor 93 of the photographing section 21 or by outputting a voice guidance from the loudspeaker 224.

(Image Editing)

After the end of the guidance, the editing control section 313 controls the editing section 12 which corresponds to an edit space, i.e. either of the edit spaces A2-1 and A2-2, to which the user has moved after ending the photography control, so that the editing section 12 performs image editing (step S3). Specifically, the editing control section 313 prompts the user to select a composition image to be synthesized with an image selected or obtained as the edit target image. The editing control section 313 then prompts the user to synthesize the composition image selected by the user with the image selected or obtained as the edit target image. Subsequently, the editing control section 313 performs an edit on a composite image obtained by the synthesis, according to an editing operation performed by the user. The edit performed on the image to be transmitted to the portable terminal 6 further includes, for example, processing for trimming the image into a predetermined size, color filter-based filtering, and processing of combining a plurality of images into a single image as a collage.

After the end of the editing, the editing control section 313 guides the user who has ended the editing control in the edit space A2-1 or the edit space A2-2 to move to the post-service space A3. This guidance is performed by displaying a guidance screen on the tablet-containing monitor 131 or by outputting an audio guidance from the loudspeaker 231.

(Photograph Sticker Printing)

After the end of the guidance, the printing control section 314 outputs the image selected by the user to the printer 241 and then causes the printer 241 to print the image on a sticker sheet (step S4). Upon completion of the printing, the post-service control section 315 causes the tablet-containing monitor 161 to display thereon a message indicating the completion of the printing, and the printer 241 discharges a post-printing sticker sheet to the sticker sheet discharge opening 164. The post-printing sticker sheet contains a predetermined image printed in a center portion thereof, a sticker ID created by the photograph sticker creating apparatus 1, and image obtainment information (e.g. URL of a web site for obtaining an image or an email address for obtaining an image). The sticker ID and the image obtainment information are printed in a margin of the post-printing sticker sheet and are provided so that the image is obtainable in the same procedure from the management server 4 and the photograph sticker creating apparatus 1.

Note that the photograph sticker creating apparatus 1 may create the image ID and the sticker ID with use of attendant information obtained without communications, by using the same algorithm as the one used for the management server 4 to create the image ID and the sticker ID. In this case, the photograph sticker creating apparatus 1 can obtain the image ID and the sticker ID without a need for the management server 4 to create the image ID and the sticker ID, and the management server 4 can appropriately recognize the image ID and sticker ID created by the photograph sticker creating apparatus 1 to identify an image stored in a corresponding temporary storage database. For example, the sticker ID is generated based on the date and time of photographing and the apparatus ID, while the image ID is created based on the date and time of photographing, the apparatus ID, and the serial number.

(Post-Service)

During the printing, the post-service control section 315 controls the post-service section 13 to control a process involved with a post-service provided to the user who is waiting for the printing to complete (step S5). Specifically, the post-service control section 315 controls, as the process involved with a post-service performed by the post-service section 13, a process for transmitting, to the management server 4, an image (including an edited image) obtained in the photograph sticker creating game. At this time, the post-service control section 315 causes the tablet-containing monitor 161 to display (i) an email address entry screen for entering an email address of a user who has played the game and (ii) a screen for selecting an image to be transmitted. By using the stylus 162A or the stylus 162B, the user enters his/her email address being currently used and selects an image to be transmitted to the management server 4.

Further, the post-service control section 315 may cause the tablet-containing monitor 161 to display an entry screen for allowing the user to enter an attribute of a captured image. For example, the post-service control section 315 may cause the tablet-containing monitor 161 to display an entry screen for allowing the user to enter information such as an edit to an image, a person captured in an image, the appearance of an object captured in an image, the shape of an image to be saved (e.g. an image intended for SNS use or an image intended for portable terminal use), and a part of an object captured in an image, (whole body, close-up, or the like), and an event related to an image, so that the edit information, the person information, the appearance information, the shape information, the photography part information, the event information, and other information can be generated on the basis of an item(s) of information entered in the entry screen by the user. In this case, the post-service control section 315 may be arranged so as to allow the user to review the items of information that the user has filled out in the entry screen and then make revision, deletion, and/or addition with respect to the items of information. Further, the post-service control section 315 may be arranged so as to allow the user to specially add comments.

This allows the user to provide an image with an attribute (tag), thus facilitating organization of images stored in the management server 4. Further, in response to the user's selection of a shape of an image to be saved, the management server 4 saves the corresponding image in the user-specified shape. This allows the user to easily post an image intended for SNS use, which image is stored in the management server 4, onto an SNS. Further, the user makes the above entries during a period of time that the user waits for the completion of the printing. This leads to an effective use of the period of time that the user waits for the completion of the printing.

Note that the service of allowing the user to provide an image with an attribute may be provided to only a paid member.

(Image Transmission)

The communication control section 311 transmits (i) an entered email address and (ii) a selected image or an image determined as an image to be transmitted by the control section 201, to the management server 4 via the communication section 203 (step S6). The image to be transmitted is associated with an identifier (image ID) for uniquely identifying the image. The image to be transmitted may be further associated with information such as date-and-time information of the image, an apparatus ID, edit information, person information, appearance information, shape information, photography part information, photography angle-of-view information, and occupying area information. The communication section 403 of the management server 4 receives the email address, image, and image ID, and others transmitted from the photograph sticker creating apparatus 1 (step S7) and then outputs them to the communication control section 411. The communication control section 411 saves the received image onto a temporary storage database (not illustrated) of the storage section 402. Data of a saved image and other data are kept stored in the temporary storage database until a lapse of a predetermined time period. After the lapse of the predetermined time period, the data is automatically deleted from the temporary storage database.

Note that, in view of the possibility that the user may become a paid member in the future, the communication control section 311 may transmit, to the management server 4, all images generated in a single play, rather than a predetermined number of images selected by the user.

With this arrangement, after the user registers himself or herself as a paid member on the website, the user can obtain all images captured as he or she was a free member.

(Creation and Transmission of Guidance Email)

The communication control section 411 outputs the received email address and image ID to the email creating section 412. Note that in the case where the sticker sheet has the sticker ID printed thereon, the image ID is not necessarily included in an email. The email creating section 412 creates a guidance email to be transmitted to the email address received from the communication control section 411. The guidance email is an email for guiding the user to save an image. A procedure for creating the guidance email is as follows. The email creating section 412 outputs the image ID to the webpage creating section 413 and requests the webpage creating section 413 to generate a URL 1102 of a web page for saving an image specified by the image ID. The management server 4 may be alternatively arranged such that the email creating section 412 creates an email that prompts the user to enter an image ID to request a URL for saving an image. The webpage creating section 413 generates the requested URL 1102 and then outputs it to the email creating section 412.

The email creating section 412 obtains, from the email database 421, data for creating a guidance email. Then, the email creating section 412 creates a guidance email 1101 illustrated in (a) of FIG. 15 by using the data obtained from the email database 421, the URL 1102, and the user's email address. A body text of the guidance email 1101 includes the URL 1102. The email creating section 412 outputs the created guidance email 1101 to the communication control section 411. The communication control section 411 transmits the guidance email 1101 to the user's email address via the communication section 403 (step S8).

Alternatively, the email creating section 412 may transmit a guidance email that contains an URL of a web page for only prompting the user to enter the sticker ID rather than an URL of a web page providing the image ID and its corresponding image. In this arrangement, the management server 4 may accept, on a web page of the URL contained in the guidance email, an entry of the sticker ID printed in a margin of the sticker sheet from the portable terminal 6, and then cause the image having been received by the management server 4 to be displayed on the portable terminal 6.

(Request and Transmission of Web Page for Saving Image)

The communication section 603 of the portable terminal 6 receives the guidance email 1101 having been transmitted from the management server 4 (step S9), and then outputs the guidance email 1101 to the communication control section 611. The communication control section 611 outputs the incoming guidance email 1101 to the display control section 613. The display control section 613 outputs the incoming guidance email 1101 to the display section 605. The user views the guidance email 1101 being displayed on the display section 605, and then selects the URL 1102 through the use of the input section 604 to save an image onto the image providing website (step S10). Note that the image ID may be entered by the user.

The input control section 612 accepts the selection entry made through the use of the input section 604 and then notifies the communication control section 611 that the URL 1102 has been selected. Upon receipt of the notification, the communication control section 611 requests the management server 4 for a web page corresponding to the selected URL 1102. A specific procedure is as follows. The communication control section 611 obtains the user's member ID stored in the storage section 602, and then transmits a predetermined request, containing that user's member ID, for making a request for providing a web page, to the management server 4 via the communication section 603.

The communication control section 411 receives the incoming request via the communication section 403 (step S11), and then outputs the received request to the webpage creating section 413. The webpage creating section 413 refers to the member database 422 for the member ID contained in the request to determine what type of member the user is (step S12). In the present embodiment, the webpage creating section 413 determines whether the user is a free member or a paid member, and then creates a web page corresponding to a result of the determination. When determining that the user is a free member, the webpage creating section 413 creates a web page 1103 for allowing a free member to save an image (see (b) of FIG. 15). On the other hand, when determining that the user is a paid member, the webpage creating section 413 creates a web page 1107 for allowing a paid member to save an image (see (c) of FIG. 15).

Note that, before the image saving, a transition may be made to a web page on which items of information related to the image can be revised, added, and/or changed.

As illustrated in (b) of FIG. 15, the web page 1103 contains a single thumbnail image 1104, a link image 1105 for prompting the user to register himself or herself as a paid member, and a link image 1106 for saving a single image onto the image providing website. In the case where the user is a free member, the user is allowed to save a single image onto the image providing website. Accordingly, the thumbnail image 1104 is a thumbnail of a single image. The single image refers to an image selected by the user at the photograph sticker creating apparatus 1. On the other hand, in the case where a plurality of images have been captured at the photograph sticker creating apparatus 1, the thumbnail image 1104 is a thumbnail of any one of the plurality of images.

As illustrated in (c) of FIG. 15, the web page 1107 contains a single thumbnail image 1104 and a link image 1108 for saving all images.

Since the present embodiment assumes that the user is a free member, the webpage creating section 413 creates the web page 1103 provided for a free member. The webpage creating section 413 outputs the created web page 1103 to the communication control section 411. The communication control section 411 transmits the incoming web page 1103 to the portable terminal 6 via the communication section 403 (step S13).

(Image Saving)

The portable terminal 6 receives the web page 1103 via the communication section 603 (step S14). The web page 1103 is outputted to the display control section 613 via the communication control section 611. The display control section 613 outputs the incoming web page 1103 to the display section 605. The user views the web page 1103 being displayed on the display section 605. In the case where the user is a free member, the user is allowed to save a single image onto the image providing website. If there are a plurality of images, any one of the plurality of images is allowed to be saved onto the image providing website. In the case where the user intends to save a single image, the user selects the image 1106 through the use of the input section 604. Note that the image that the user intends to save is not limited to an image selected as an image to be transmitted to the portable terminal 6 at the photograph sticker creating apparatus 1, and may be, for example, an image designated as an image to be saved by the portable terminal 6 accessing the image providing website.

The input control section 612 accepts a selection entry made through the use of the input section 604 and then notifies the communication control section 611 that the link image 1106 has been selected. Upon receipt of the notification, the communication control section 611 transmits, to the management server 4, an instruction to save the image (step S15).

The instruction to save an image is received by the communication control section 411 via the communication section 403 (step S16). Then, the communication control section 411 instructs the image management section 414 to save the image. Upon receipt of the instruction, the image management section 414 generates image management information on the image that has been captured of the user and stored in the temporary storage database, associates the image with the generated image management information, associates the image associated with the image management information with the user's member ID, and then saves the image associated with the user's member ID onto the image database 424 (step S17). At that time, if the image is a single image, that image is saved. On the other hand, if the image is a plurality of images, any one of the plurality of images (e.g. an image corresponding to the thumbnail image 1104) is saved. This completes the series of steps illustrated in FIG. 14.

Note that when having an intention to save all images, the user who is a free member selects the link image 1105. In this case, a series of steps for paid member registration are performed by the captured-image management system 10. Then, after the completion of the registration, all images are associated with the user's member ID and then the images are saved onto the image database 424.

Further, a process for saving the images when the user is a paid member is basically identical to the aforementioned process taken when the user is a free member, except that the user selects the link image 1108 contained in the web page 1107. Then, the management server 4 saves all images onto the image storage area dedicated to the user in the image database 424. Note that the user's selection of an image(s) to be saved (a single image for a free member or all images for a paid member) may be accepted by the photograph sticker creating apparatus 1. In this arrangement, the image management section 414 may save, onto the image database 424, an image selected at the photograph sticker creating apparatus 1.

(Saving of Image onto Portable Terminal 6)

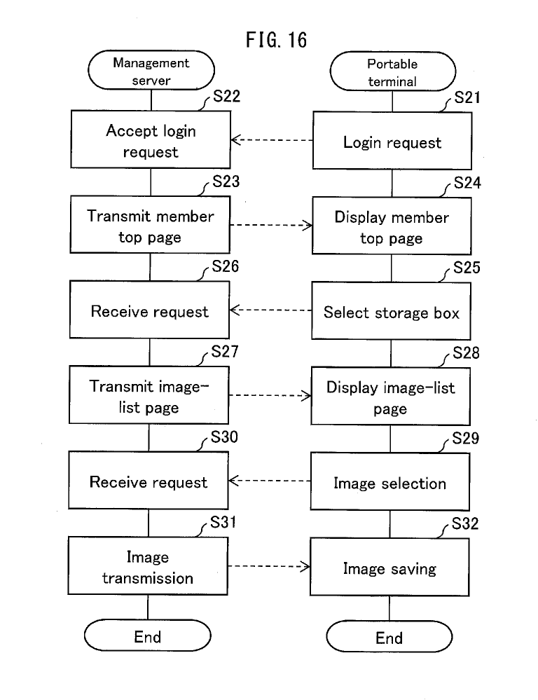

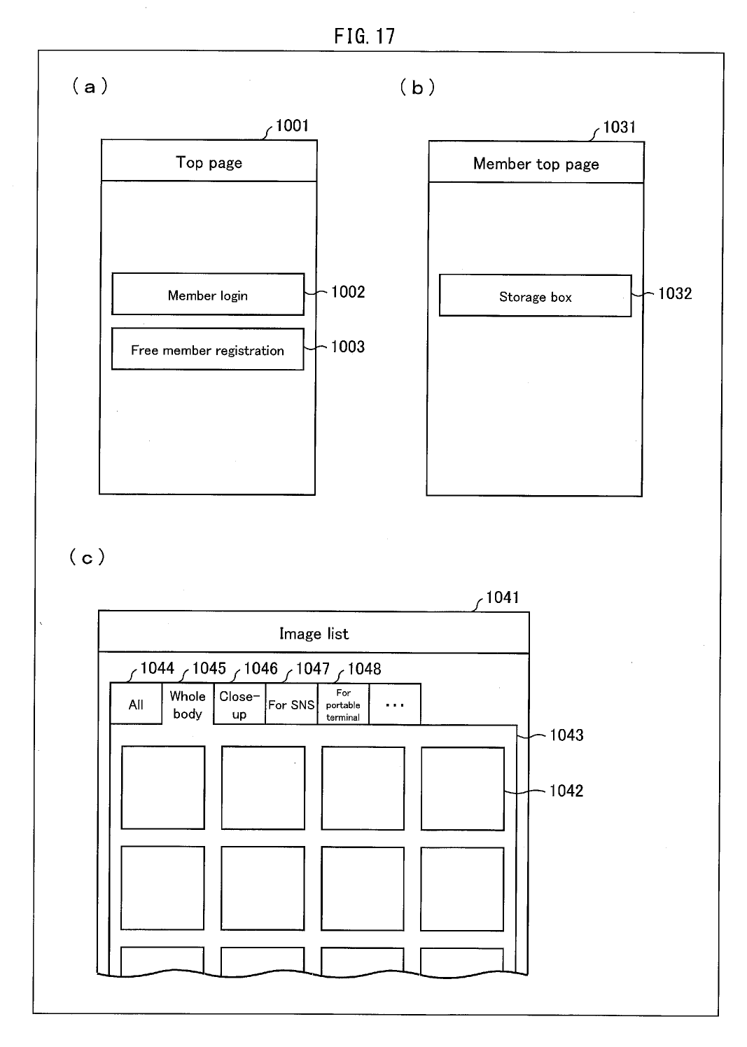

With reference to FIGS. 16 and 17, the following will describe a flow of a process for saving, onto the portable terminal 6 of the user, an image stored on the image providing website. FIG. 16 is a sequence diagram illustrating an example flow of a series of steps involved in the saving of an image onto the portable terminal 6 in the captured-image management system 10. FIG. 17 is a screen flow diagram illustrating an example web page displayed on the display section 605 of the portable terminal 6 during the process for saving an image onto the portable terminal 6.

The user accesses the image providing website to log in to the image providing website. Then, a top page 1001 (see (a) of the FIG. 17) of the image providing website is displayed on the display section 605 of the portable terminal 6. By operating the input section 604 of the portable terminal 6, the user selects the link image 1002 for proceeding with a process of login as a member to the image providing website. When accepting the selection operation, the input control section 612 notifies the communication control section 611 that the link image 1002 has been selected. Upon receipt of the notification, the communication control section 611 reads a user's member ID and a password from the storage section 602. Subsequently, the communication control section 611 transmits, to the management server 4, the user's member ID and the password via the communication section 603 and requests the management server 4 for permission to log in to the image providing website (step S21). Alternatively, in the case where the link image 1002 has been selected, the communication control section 611 may obtain a web page for entering a user's member ID and a password. In this case, the management server 4 accepts the entries of the user's member ID and password on the web page.

The communication control section 411 of the management server 4 accepts this request via the communication section 403 (step S22). Subsequently, the communication control section 411 outputs the received member ID and password to the webpage creating section 413 and instructs the webpage creating section 413 to create a member top page 1031.

The webpage creating section 413 verifies the incoming member ID and password against the member database 422 to determine whether or not the user is registered as a member on the image providing website. When determining that the user is registered as a member, the webpage creating section 413 obtains, from the web page database 423, data for generating the member top page 1031. The webpage creating section 413 generates, on the basis of the obtained data, the member top page 1031 as illustrated in (b) of FIG. 17, and then outputs the member top page 1031 to the communication control section 411. The member top page 1031 contains a link image 1032 for displaying a list of images having been captured of the user and stored on the image providing website. The communication control section 411 transmits the member top page 1031 to the portable terminal 6 via the communication section 403 (step S23).

The communication control section 611 of the portable terminal 6 receives the member top page 1031 via the communication section 603. The communication control section 611 outputs the received member top page 1031 to the display control section 613. The display control section 613 outputs the member top page 1031 to the display section 605. Then, the member top page 1031 is displayed on the display section 605 (step S24).

By operating the input section 604 of the portable terminal 6, the user selects the link image 1032 (step S25). The input control section 612 accepts the selection operation and then notifies the communication control section 611 that the link image 1032 has been selected. Then, the communication control section 611 transmits, to the management server 4 via the communication section 603, a request for providing a web page containing the list of the images having been captured of the user and stored on the image providing website.

The communication control section 411 of the management server 4 accepts, via the communication section 403, the request having been transmitted from the portable terminal 6 (step S26). Subsequently, the communication control section 411 instructs the webpage creating section 413 to generate an image-list page 1041 containing the list of the images having been captured of the user and stored in the image database 424.

The webpage creating section 413 obtains, from the web page database 423, data for generating the image-list page 1041. The webpage creating section 413 uses the obtained data and refers to all of the images having been captured of the user and stored in the image database 424, thereby generating the image-list page 1041 illustrated in (c) of FIG. 17. Then, the webpage creating section 413 outputs the image-list page 1041 to the communication control section 411. The image-list page 1041 contains a plurality of thumbnail images 1042 which show, on a one-to-one basis, all of the images having been captured of the user and stored in the image database 424. The communication control section 411 transmits the image-list page 1041 to the portable terminal 6 via the communication section 403 (step S27: page creating step).

As illustrated in (c) of FIG. 17, the image-list page 1041 contains a plurality of tab-selectable album pages 1043 in the present invention. In an example illustrated in (c) of FIG. 17, the image-list page 1041 contains a plurality of album pages selectable by tabs including, for example, an “ALL” tab 1044, a “WHOLE BODY” tab 1045, an “CLOSE-UP” tab 1046, an “FOR SNS” tab 1047, and a “FOR PORTABLE TERMINAL” tab 1048. The “FOR SNS” tab 1047 may be replaced with more specific tabs such as a tab for SNS icons and a tab for SNS banners. (c) of FIG. 17 illustrates a situation where, when the “WHOLE BODY” tab 1045 is clicked, the album page 1043 shows captured images of the whole body of the user, out of all of the images having been captured of the user and stored in the image database 424. In other words, the album page 1043 shows the images with which the photography part information “whole body” is associated, out of all of the images having been captured of the user and stored in the image database 424.

The communication control section 611 of the portable terminal 6 receives the image-list page 1041 via the communication section 603. The communication control section 611 outputs the received image-list page 1041 to the display control section 613. The display control section 613 outputs the image-list page 1041 to the display section 605. Then, the image-list page 1041 is displayed on the display section 605 (step S28).

By operating the input section 604 of the portable terminal 6, the user selects, from among the thumbnail images 1042 being displayed, the thumbnail images 1042 corresponding to an image that the user intends to save onto the portable terminal 6 (step S29). The input control section 612 accepts the selection operation and then notifies the communication control section 611 that the thumbnail image 1042 has been selected. Then, the communication control section 611 transmits, to the management server 4 via the communication section 603, a request for providing the image corresponding to the selected thumbnail image 1042.

The communication control section 411 of the management server 4 receives, via the communication section 403, the request having been transmitted from the portable terminal 6 (step S30). Subsequently, the communication control section 411 instructs the image management section 414 to output, to the communication control section 411, the image of the user which image is specified by the request from the portable terminal 6.

The image management section 414 obtains the specified image from the image database 424, and then outputs the obtained image to the communication control section 411. The communication control section 411 transmits the incoming image to the portable terminal 6 via the communication section 403 (step S31).

The communication control section 611 of the portable terminal 6 receives, via the communication section 603, the image having been transmitted from the portable terminal 6, and then saves the received image onto the storage section 602 (step S32), and the process for saving an image onto the portable terminal 6 ends.

The above descriptions have taken, as an example, the arrangement in which the portable terminal 6 logs in to the image providing website to obtain an intended image. Alternatively, the intended image can be obtained by using the sticker ID in the present embodiment. For example, the portable terminal 6 accesses a web page corresponding to a URL printed on the sticker sheet (or URL contained in the guidance email). The portable terminal 6 accepts an entry of the sticker ID by the user and then accesses the web page for obtaining an image.

In the case where the user is a paid member, the web page for obtaining an image may show, in a user-selectable form, a list of all images identified by the sticker ID and having been generated in a single game. In the case where the user is a free member, the web page for obtaining an image may show, in a user-selectable form, a list of only a single image out of all of the images identified by the sticker ID. Further, in the case where the user is a free member, the web page for obtaining an image may show only a single image having been selected beforehand at the photograph sticker creating apparatus 1. The image(s) shown in list form on the web page for obtaining an image are preferably an edited image(s) only. However, a manner that the web page for obtaining an image shows images is not limited to any specific manner. For example, in the case where a captured image(s) for which its corresponding edited image(s) is not generated is present, the web page for obtaining an image may show a list of (i) an edited image(s) and the captured image(s) for which its corresponding edited image(s) is not generated or may show a list of all edited image(s) and all captured image(s).

The portable terminal 6 obtains, out of the images shown in list form on the web page for obtaining an image, a user-selected image from the management server 4, and then saves the obtained image onto the storage section 602. Note that in the case where the user is a paid member, the portable terminal 6 may obtain all of the images shown in list form from the management server 4 and then save the obtained images onto the storage section 602, without having to accept a user's selection operation performed on any of the images shown in list form on the web page for obtaining an image.

While the image-list page 1041 is displayed on the portable terminal 6, the user may be allowed to enter items of information on each image shown in the image-list page 1041. The items of information include, for example, an edit to the image (e.g. a stamp used in the edit and a character string inserted through the edit), the appearance of the user captured in the image, a person captured in the image, and a part captured in the image. In this arrangement, the portable terminal 6 transmits, to the management server 4, the items of information having been entered by the user, such as the editing information, the appearance information, the person information, and the photography part information.

Further, while the image-list page 1041 is displayed on the portable terminal 6, the shape of each image being saved may be changed by the user. In this arrangement, the management server 4 receives the shape information from the portable terminal 6 and then changes the shape of the specified image being saved.

Still further, while the image-list page 1041 is displayed on the portable terminal 6, the user may be allowed to edit each of the images on the portable terminal 6 by using, for example, a “graffiti” application. In this arrangement, the management server 4 receives an edited image from the portable terminal 6 and then updates image management information of the received edited image. For example, the management server 4 may be arranged to analyze the edited image and then generate, for example, “stamp use flag”, “character string information”, and “event information”. Further, the management server 4 may be arranged to receive the edit information from the portable terminal 6 and then generate, for example, “stamp use flag”, “character string information”, and “event information”.

As described earlier, the user is allowed to save, onto the image providing website (management server 4) by means of the portable terminal 6 or others, an image other than the images that the user has captured at the photograph sticker creating apparatus 1.

Here, the webpage creating section 413 may present, on the image-list page 1041, attributes of the individual images, i.e. details of the items of image management information of the individual images. Alternatively, the webpage creating section 413 may cause an attribute of the image 1042 to appear on the portable terminal 6, only after the image 1042 has been selected. This allows the user to grasp, for example, what color-tone correction process has been performed on the image by what kind of application.

Further, when any of the images 1042 is selected on the image-list page 1041 being displayed on the portable terminal 6, the webpage creating section 413 may retrieve another image(s) having the same attribute as that of the selected image 1042, create a new album page having the retrieved image(s) presented thereon, and then output the created album page to the portable terminal 6. For example, when the user selects a sepia-tone corrected image while the image-list page 1041 is displayed on the portable terminal 6, an album page presenting sepia-tone corrected image(s) is displayed on the portable terminal 6.

Still further, while the image-list page 1041 is displayed on the portable terminal 6, the user may be allowed to add the same attribute of a certain image to other image. For example, by operating the portable terminal 6, the user selects a sepia-tone corrected image and an image targeted for addition of an attribute and enters an attribute addition instruction. Upon receipt of the instruction from the portable terminal 6, the image management section 414 of the management server 4 performs sepia-tone correction on the user-selected image targeted for addition of an attribute, and then saves the color-tone corrected image onto the storage section 402.

The present embodiment employs the arrangement in which the webpage creating section 413 of the management server 4 generates the image-list page 1041, and the portable terminal 6 receives, from the management server 4, data for displaying the image-list page 1041, and displays the image-list page 1041. The present embodiment is, however, not limited to this arrangement. For example, an arrangement may be alternatively employed in which the display control section 613 (page creating section) of the portable terminal 6 has a function of creating a page and creates the image-list page 1041 on the basis of the data received from the management server 4.

Specifically, the communication control section 611 of the portable terminal 6 receives, from the management server 4, data necessary for creating the image-list page 1041 (for example, image viewer or the like application) beforehand. Then, when the communication control section 611 of the portable terminal 6 receives, from the management server 4, images and their corresponding items of image management information, the display control section 613 of the portable terminal 6 creates, on the basis of the data having been received beforehand, a template of the image-list page 1041 containing the plurality of album pages 1043 that are selectable for display. Subsequently, the display control section 613 sorts the received images into groups according to the type of the images on the basis of the received items of image management information, and then creates the image-list page 1041 that contains a plurality of album pages showing the respective groups of the images. The display control section 613 then causes the created image-list page 1041 to be displayed on the display section 605.

A method of sorting the images into groups on the basis of the image management information and showing the groups of images in list form, may be arranged such that any relevant group of images is retrieved from a list of the groups of images through the use of a specific search key, and the retrieved group of images is displayed. Further, sorting information items on which links to the image-list page are provided may be shown in a list form. Still further, a predetermined tune as background music may be played during viewing of images. The list of the groups of images may be displayed in slide show form. In the present embodiment, the images shown on the image-list page 1041 are shown in thumbnail view. Alternatively, the images may be shown in a given size so that flicking the screen of the portable terminal 6 to left or right flips each of the images. Further, an image shown on the image-list page 1041 may be randomly changed to another every lapse of a predetermined time period. Still further, when a specific image is displayed in an enlarged view, its corresponding image information may be displayed below the image at a predetermined position. A text of the image information may be displayed as a telop running from the left to right at a predetermined rate.

[Recap]

In order to solve the above problem, a management apparatus of the present invention is a management apparatus for connecting to a terminal device of a user's and to a photograph sticker creating apparatus over a communication network and providing data displayable by the terminal device, the management apparatus including: a page creating section for creating an image-list page including a plurality of album pages that are selectable for display and that serve to display on the terminal device a plurality of images which have been captured at the photograph sticker creating apparatus and which are associated with the user, the page creating section being configured to sort the plurality of images into types on a basis of at least one of (i) image processing information indicative of a process having been performed on at least one of the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

In order to solve the above problem, a method of the present invention for controlling a management apparatus is a method for controlling a management apparatus for connecting to a terminal device of a user's and to a photograph sticker creating apparatus over a communication network and providing data displayable by the terminal device, the method including the step of: (a) creating an image-list page including a plurality of album pages that are selectable for display and that serve to display on the terminal device a plurality of images which have been captured at the photograph sticker creating apparatus and which are associated with the user, the step (a) being configured to sort the plurality of images into types on a basis of at least one of (i) image processing information indicative of a process having been performed on the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

With either of the above arrangements, the management apparatus is capable of causing a terminal device of the user's to display images, sorted into types on the basis of at least one of the image processing information, the object information, and the operation information, on a plurality of album pages for the respective types. The management apparatus sorts images different purposes as desired by the user and creates album pages for such purposes, which advantageously allows the user to access a desired image rapidly.

The management apparatus of the present invention may preferably be arranged such that the image processing information includes shape information indicative of a shape of the at least one of the plurality of images.

With the above arrangement, the management apparatus sorts images according to the shape of each image to create album pages. This allows the user to rapidly access an image of a desired shape.

The management apparatus of the present invention may preferably be arranged such that the image processing information includes edit information indicative of an edit to the at least one of the plurality of images.

With the above arrangement, the management apparatus sorts images according to an edit to each image to create album pages. This allows the user to rapidly access an image edited as desired.

The management apparatus of the present invention may preferably be arranged such that the object information includes part information indicative of a part of the at least one object which part is shown in the at least one of the plurality of images.

With the above arrangement, the management apparatus sorts images according to the part of the at least one object which part is captured in each image and thus creates album pages. This allows the user to rapidly access an image captured of a desired part.

The management apparatus of the present invention may preferably be arranged such that the object information includes appearance information indicative of an appearance of the at least one object shown in the at least one of the plurality of images.

With the above arrangement, the management apparatus sorts images according to the appearance of the at least one object captured in each image and thus creates album pages. This allows the user to rapidly access an image captured of at least one object with a desired appearance.

The management apparatus of the present invention may preferably be arranged such that the edit information includes character-string information indicative of a character string inserted through the edit in the at least one of the plurality of images.

With the above arrangement, the management apparatus sorts images according to the character string(s) inserted through an edit in each image and thus creates album pages. This allows the user to rapidly access an image with a desired character string written therein.

The management apparatus of the present invention may preferably be arranged such that the edit information includes stamp information indicative of a stamp inserted through the edit in the at least one of the plurality of images.

With the above arrangement, the management apparatus sorts images according to the stamp(s) inserted through an edit in each image and thus creates album pages. This allows the user to rapidly access an image having a desired stamp.

The management apparatus of the present invention may preferably be arranged such that the object information includes person information indicative of a person shown in the at least one of the plurality of images.

With the above arrangement, the management apparatus sorts images according to the person(s) captured in each image and thus creates album pages. This allows the user to rapidly access an image captured of a desired person.

The management apparatus of the present invention may preferably be arranged such that the image processing information includes event information indicative of an event related to the at least one of the plurality of images.

With the above arrangement, the management apparatus sorts images according to an event related to each image to create album pages. This allows the user to rapidly access an image related to a desired event.

The management apparatus of the present invention may preferably be arranged such that the image processing information includes manipulator information indicative of a section that has performed a manipulation process having been performed on the at least one of the plurality of images.

With the above arrangement, the management apparatus sorts images according to the section that has performed a manipulation process performed on each image and thus creates album pages. This allows the user to rapidly access an image manipulated by a desired section (for example, an apparatus or an application).

The management apparatus of the present invention may preferably be arranged such that the image processing information includes collage information indicative of the number of captured images included in the at least one of the plurality of images.

With the above arrangement, the management apparatus sorts images according to the number of captured images included in each image and thus creates album pages. This allows the user to rapidly access a desired collage image.

The management apparatus of the present invention may preferably be arranged such that at least one of the image processing information, the object information, and the operation information has been entered by the user during a post-service at the photograph sticker creating apparatus.

With the above arrangement, the management apparatus creates album pages on the basis of information entered by the user while the user is playing a game at the photograph sticker creating apparatus. This allows a game at the photograph sticker creating apparatus to be in conjunction with image viewing at the terminal device.

The management apparatus of the present invention may preferably be arranged such that at least one of the image processing information, the object information, and the operation information has been entered by the user with use of the terminal device, which is connected to the management apparatus over the communication network.

With the above arrangement, the management apparatus creates album pages on the basis of information entered by the user with use of the terminal device. This allows the user to cause images to be sorted in any manner for display.

The management apparatus of the present invention may preferably further include: an image analyzing section for generating at least one of the image processing information, the object information, and the operation information through an analysis of the at least one of the plurality of images.

With the above arrangement, the management apparatus automatically generates from each image at least one of the image processing information, the object information, and the operation information. This allows the management apparatus to automatically sort images.

The management apparatus of the present invention may preferably be arranged such that the page creating section is configured to, only in the case where the user is a particular type of member, sort the plurality of images into types and show the plurality of images on the plurality of album pages for the respective types.

With the above arrangement, the management apparatus can provide the above album page viewing service as a special service for a user having a particular member status. This allows the management apparatus to provide different services according to different member statuses of users. The particular member status is, for example, a paid member.

The management apparatus of the present invention may preferably be arranged such that the page creating section extracts a region for a face of a person shown in the at least one of the plurality of images and shows an image of the face on the image-list page.

With the above arrangement, the management apparatus automatically generates facial images and creates an image-list page that shows those facial images. The management apparatus can, with the above arrangement, provide an additional service of automatic extraction and viewing of facial images.

The management apparatus of the present invention may preferably further include: an image management section for generating a moving image with use of the plurality of images associated with the user.

With the above arrangement, the management apparatus automatically generates a moving image with use of a plurality of images owned by the user. The management apparatus can, with the above arrangement, provide an additional service of generation and viewing (playing) of a moving image.

In order to solve the above problem, a terminal device of the present invention is a terminal device for (i) connecting over a communication network to a management apparatus for managing an image captured at a photograph sticker creating apparatus and (ii) receiving data from the management apparatus, the terminal device including: a page creating section for creating an image-list page including a plurality of album pages that are selectable for display and that show a plurality of images which have been captured at the photograph sticker creating apparatus and which are associated with a user, the page creating section being configured to sort the plurality of images into types on a basis of at least one of (i) image processing information indicative of a process having been performed on at least one of the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

With the above arrangement, the terminal device is capable of displaying images, sorted into types on the basis of at least one of the image processing information, the object information, and the operation information, on a plurality of album pages for the respective types. The terminal device sorts images different purposes as desired by the user and creates album pages for such purposes, which advantageously allows the user to access a desired image rapidly.

The terminal device according to the foregoing embodiments of the present invention may be in the form of a computer. In this case, the present invention encompasses: a control program for the terminal device which program causes a computer to operate as each of the above sections of the terminal device so that the terminal device can be in the form of a computer; and a non-transitory computer-readable storage/recording medium storing the control program.

[Software Implementation Example]

Control blocks of the photograph sticker creating apparatus 1, management server 4, and the portable terminal 6 (particularly, the control section 201, the control section 401, and the control section 601) may be realized by a logic circuit (hardware) provided in an integrated circuit (IC chip) or the like, or may be realized by software as executed by a central processing unit (CPU).

In the latter case, the photograph sticker creating apparatus 1, the management server 4, and the portable terminal 6 each include: a CPU that executes instructions of a program that is software realizing the foregoing functions; a read only memory (ROM) or storage device (each referred to as “storage medium”) storing the program and various kinds of data in such a form that they are readable by a computer (or a CPU); and a random access memory (RAM) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### INDUSTRIAL APPLICABILITY

The present invention is widely applicable as a captured-image management system in which an image captured of a user at a photograph sticker creating apparatus is saved onto a management server.

### REFERENCE SIGNS LIST

1 photograph sticker creating apparatus
4 management server (management apparatus)
6 portable terminal (terminal device)
11 photography unit
12 editing section
13 post-service section
21 photographing section
201 control section
311 communication control section
312 photography control section
313 edit control section
314 printing control section
315 post-service control section
316 image analyzing section
401 control section
402 storage section
403 communication section
411 communication control section
412 email creating section
413 web page creating section (page creating section)
414 image management section
601 control section
602 storage section
603 communication section
604 input section
605 display section
611 communication control section
612 input control section
613 display control section (page creating section)

1. A management apparatus for connecting to a terminal device of a user's and to a photograph sticker creating apparatus over a communication network and providing data displayable by the terminal device,
the management apparatus comprising:
a page creating section for creating an image-list page including a plurality of album pages that are selectable for display and that serve to display on the terminal device a plurality of images which have been captured at the photograph sticker creating apparatus and which are associated with the user,
the page creating section being configured to sort the plurality of images into types on a basis of at least one of (i) image processing information indicative of a process having been performed on at least one of the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

2. The management apparatus according to claim 1,
wherein:
the image processing information includes shape information indicative of a shape of the at least one of the plurality of images.

3. The management apparatus according to claim 1,
wherein:
the image processing information includes edit information indicative of an edit to the at least one of the plurality of images.

4. The management apparatus according to claim 1,
wherein:
the object information includes part information indicative of a part of the at least one object which part is shown in the at least one of the plurality of images.

5. The management apparatus according to claim 1,
wherein:
the object information includes appearance information indicative of an appearance of the at least one object shown in the at least one of the plurality of images.

6. The management apparatus according to claim 3,
wherein:
the edit information includes character-string information indicative of a character string inserted through the edit in the at least one of the plurality of images.

7. The management apparatus according to claim 3,
wherein:
the edit information includes stamp information indicative of a stamp inserted through the edit in the at least one of the plurality of images.

8. The management apparatus according to claim 1,
wherein:
the object information includes person information indicative of a person shown in the at least one of the plurality of images.

9. The management apparatus according to claim 1,
wherein:
the image processing information includes event information indicative of an event related to the at least one of the plurality of images.

10. The management apparatus according to claim 1,
wherein:
the image processing information includes manipulator information indicative of a section that has performed a manipulation process having been performed on the at least one of the plurality of images.

11. The management apparatus according to claim 1,
wherein:
the image processing information includes collage information indicative of the number of captured images included in the at least one of the plurality of images.

12. The management apparatus according to claim 1,
wherein:
at least one of the image processing information, the object information, and the operation information has been entered by the user during a post-service at the photograph sticker creating apparatus.

13. The management apparatus according to claim 1,
wherein:
at least one of the image processing information, the object information, and the operation information has been entered by the user with use of the terminal device, which is connected to the management apparatus over the communication network.

14. The management apparatus according to claim 1, further comprising:
an image analyzing section for generating at least one of the image processing information, the object information, and the operation information through an analysis of the at least one of the plurality of images.

15. The management apparatus according to claim 1,
wherein:
the page creating section is configured to, only in the case where the user is a particular type of member, sort the plurality of images into types and show the plurality of images on the plurality of album pages for the respective types.

16. The management apparatus according to claim 1,
wherein:
the page creating section extracts a region for a face of a person shown in the at least one of the plurality of images and shows an image of the face on the image-list page.

17. The management apparatus according to claim 1, further comprising:
an image management section for generating a moving image with use of the plurality of images associated with the user.

18. A method for controlling a management apparatus for connecting to a terminal device of a user's and to a photograph sticker creating apparatus over a communication network and providing data displayable by the terminal device,
the method comprising the step of:
(a) creating an image-list page including a plurality of album pages that are selectable for display and that serve to display on the terminal device a plurality of images which have been captured at the photograph sticker creating apparatus and which are associated with the user,
the step (a) being configured to sort the plurality of images into types on a basis of at least one of (i) image processing information indicative of a process having been performed on the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

19. A terminal device for (i) connecting over a communication network to a management apparatus for managing an image captured at a photograph sticker creating apparatus and (ii) receiving data from the management apparatus,
the terminal device comprising:
a page creating section for creating an image-list page including a plurality of album pages that are selectable for display and that show a plurality of images which have been captured at the photograph sticker creating apparatus and which are associated with a user,
the page creating section being configured to sort the plurality of images into types on a basis of at least one of (i) image processing information indicative of a process having been performed on at least one of the plurality of images, (ii) object information indicative of a state of at least one object shown in the at least one of the plurality of images, and (iii) operation information indicative of an operation having been performed at the photograph sticker creating apparatus and to show the plurality of images on the plurality of album pages for the respective types.

20. A non-transitory computer-readable storage medium storing a control program for causing a computer to function as the terminal device according to claim 19, the control program causing the computer to function as the page creating section.
